(19) United States
(12) Patent Application Publication
(10) Pub. No.: US 2005/0079098 A1
(43) Pub. Date: Apr. 14, 2005

(54) Microchemical chip

(75) Inventors: Shin Matsuda, Kokubu-shi (JP); Kuninori Yokomine, Kokubu-shi (JP); Katsuhiko Onitsuka, Kokubu-shi (JP); Masanao Kabumoto, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/877,951

(22) Filed: Jun. 24, 2004

(30) Foreign Application Priority Data
Jun. 25, 2003 (JP) P2003-181679
Jun. 25, 2003 (JP) P2003-181680
Jun. 30, 2003 (JP) P2003-187941
Jul. 28, 2003 (JP) P2003-202729

(51) Int. Cl. G01N 31/22

(52) U.S. Cl. 422/58

(57) ABSTRACT

A microchemical chip includes a base having a channel for causing fluids to-be-treated to flow therethrough, and supply portions connected to the channel, for causing the fluids to-be-treated to flow into the channel, respectively. In the microchemical chip, a plurality of fluids to-be-treated are respectively caused to flow from the supply portions into the channel, and the plurality of fluids to-be-treated caused to flow in are merged to be subjected to chemical reactions. In the microchemical chip, heaters are formed for heating the fluid to-be-treated flowing through supply channels of the supply portions.

### BACKGROUND OF THE INVENTION

1. Field of the Invention

The present invention relates to a microchemical chip in which a predetermined treatment such as a reaction or analysis can be performed with respect to a fluid to-be-treated such as a fluid flowing through a microscopic channel or a reagent. More specifically, the present invention relates to a microchemical chip in which it is possible to mix a plurality of different fluids to-be-treated and then perform a predetermined treatment, for example, as in the case where blood and a reagent are mixed to cause a reaction.

2. Description of the Related Art

In recent years, in the fields of chemical technology and biotechnology, research to perform reaction with a sample or analysis of a sample in a small area has been conducted, and microchemical systems that are miniaturized systems for chemical reactions, biochemical reactions and analysis of samples have been researched and developed, using a Micro Electro Mechanical Systems (abbreviated as MEMS) technology.

The reaction and the analysis in the microchemical systems are performed with one chip called a microchemical chip in which a microchannel, a micropump, and a microreactor are formed. For example, the following microchemical chip is proposed: a supply port for supplying a fluid such as a sample and a reagent and a collection port for guiding a treated fluid are formed in a base made of silicon, glass or resin, the supply port and the collection port are connected via a microchannel whose cross-section area is small, and a micropump for sending a fluid to an appropriate position of the microchannel is provided (see Japanese Unexamined Patent Publication JP-A 2002-214241 (pages 4-5, FIG. 1) and Japanese Unexamined Patent Publication JP-A 2002-233792 (pages 5-6, FIGS. 1 and 3)). Furthermore, a microchemical chip including means for, sending a fluid of capillary migration type utilizing an electro-osmosis phenomenon, instead of the micropump is also proposed (see Japanese Unexamined Patent Publication JP-A 2001-108619 (page 5, FIGS. 1 and 2). In these microchemical chips, the microchannels are connected or branched at predetermined positions, and fluids are mixed at the junction portion, or the fluid is separated at the branching portion.

In the microchemical system, compared with the conventional systems, the equipment and the constitution of each portion are miniaturized, and therefore the surface area of a reaction per unit volume of a sample can be increased so that the reaction time can be reduced significantly. Moreover, it is possible to control the flow rate precisely, so that reaction and analysis can be performed efficiently. Furthermore, the amount of a sample or a reagent necessary for reaction or analysis can be reduced.

Since the microchemical system has these advantages, the microchemical system is expected to be applied to the medical field. For example, since the amount of blood that is a specimen can be reduced by using a microchemical chip in a blood test burden on a patient can be reduced. Furthermore, since the amount of a reagent necessary for a test can be reduced, the cost of the test can be reduced.

Furthermore, in the medical field, it has been-examined to combine the microchemical chip with the semiconductor technology. For example, as a device used to test the blood of a patient at home or outside medical institutes, and send the test results to a medical institute, a “health care device” in which in addition to a microchannel, a micropump, and a microreactor, a needle for collecting blood, a filter for filtering blood, and a micro-spectroscope, a micro-plasma power and a detecting circuit for analyzing blood are mounted on a base made of silicon is conceived (see “NIKKEI MICRODEVICES, July, 2000”, NIKKEI Business Publications Inc., July, 2000, pp. 88-97).

With the microchemical chip, a reaction product can be produced by mixing and chemically reacting a plurality of fluids to-be-treated which are respectively supplied from a plurality of supply portions. For obtaining the reaction product at a high yield, the respective fluids to-be-treated for the reaction need to be mixed in the optimum quantities per unit time.

Since, however, the fluids to-be-treated for the reaction have different viscosities in many cases, the flow velocities of the fluids to-be-treated which are supplied from the supply portions into a channel become different due to the viscosities of the fluids to-be-treated. This leads to the problem that the fluids to-be-treated for the reaction cannot be mixed in the optimum quantities per unit time, so the reaction product cannot be obtained at the high yield.

Some of the microchemical chips include a heating treatment portion which performs a predetermined reaction treatment by heating a plurality of fluids to-be-treated respectively supplied from a plurality of supply portions and then mixed together. In such a microchemical chip including the heating treatment portion, a temperature in the heating treatment portion is sometimes changed in order to control the reactivity of the plurality of fluids to-be-treated mixed together.

When the temperature in the heating treatment portion has changed, the volume of the plurality of fluids to-be-treated mixed together changes, and the flow rate of the fluids to-be-treated which flow through a channel changes due to the volumetric change, resulting in the problem that the reactivity in the heating treatment portion degrades due to the flow rate change. Especially in a case where the volume of the plurality of fluids to-be-treated mixed together has increased on account of a temperature rise, the flow rate decreases for such a reason that the fluids to-be-treated flowing through the channel flow backwards due to the volumetric increase, resulting in the problem that the reactivity in the heating treatment portion degrades due to the flow rate decrease. Moreover, the degradation of the reactivity incurs the problem that the yield of a reaction product is lowered.

With the microchemical chip, a reaction product can be produced by mixing and chemically reacting a plurality of fluids to-be-treated which are respectively supplied from a plurality of supply portions. Some of chemical reactions for obtaining such reaction products do not proceed unless temperatures are higher than a normal temperature, and the fluids to-be-treated need to be heated for causing such a chemical reaction. Besides, in some cases, the chemical reactions which require the heating must be performed a plurality of times in order to obtain the reaction product.

In the case where the reaction product is produced by performing the chemical reactions requiring the heating, the plurality of times, a plurality of heating treatment portions need to be provided in the microchemical chip. The microchemical chip, however, has a small construction in itself. Accordingly, when the plurality of heating treatment portions are provided, heat from each of the heating treatment portions acts on another, and a precise temperature control in each heating treatment portion becomes difficult. Therefore, the conventional microchemical chip has the problem that, in the case where the reaction product is to be produced by performing the chemical reactions which require the heating, the plurality of times, the individual chemical reactions become incomplete, so the desired reaction product cannot be obtained at a high yield.

The microchemical chip has been disadvantageous as stated below. Fluids to-be-treated supplied from supply portions are subjected to a predetermined treatment in a reaction portion. The treatment sometimes requires, for example, precise and uniform heating in order to generate a predetermined reaction. Nevertheless, heat from a heater disposed for the heating diffuses in a base, and a temperature becomes lower at the outer peripheral parts of the heater than at the central part thereof, so that a temperature difference arises between the central part and outer peripheral parts of the heater, and the temperature of the reaction portion cannot be uniformly controlled. Therefore, the reaction cannot be precisely controlled.

### SUMMARY OF THE INVENTION

An object of the invention is to provide a microchemical chip in which the flow rates of fluids to-be-treated that are supplied from supply portions can be regulated, whereby the plurality of different fluids to-be-treated can be efficiently mixed to obtain a reaction product at a high yield.

Another object of the invention is to provide a microchemical chip in which the reactivity of a plurality of mixed fluids to-be-treated is not lowered, and the yield of a reaction product is high.

Still another object of the invention is to provide a microchemical chip which permits a precise temperature control to proceed in each of a plurality of heating treatment portions, whereby a reaction product which is produced by performing chemical reactions requiring heating, a plurality of times, can be obtained at a high yield.

Still another object of the invention is to provide a microchemical chip which can make small the temperature difference between the central part and outer peripheral parts of a heater so as to uniformly control the temperature of a reaction portion.

The invention provides a microchemical chip comprising:
a base including a channel for causing fluids to-be-treated to flow therethrough, and a plurality of supply portions connected to the channel, for causing the plurality of fluids to-be-treated to flow into the channel, respectively, the plurality of fluids to-be-treated being respectively caused to flow from the plurality of supply portions into the channel, and the plurality of fluids to-be-treated caused to flow in being merged to be subjected to a predetermined treatment,
wherein each of the supply portions includes a supply channel, one end of which is connected to an opening formed in the base and another end of which is connected to the channel, and heating means for heating the fluid to-be-treated flowing through the supply channel.

According to the invention, when the fluids to-be-treated are caused to flow in from the plurality of supply portions, the fluids to-be-treated caused to flow in are merged and caused to flow through the channel, whereby the predetermined treatment is performed. Accordingly, when the plurality of different fluids to-be-treated are respectively caused to flow in from the plurality of supply portions, the plurality of fluids to-be-treated caused to flow in are merged and caused to flow through the channel, whereby the predetermined treatment is performed. The plurality of supply portions and the channel may be connected at the identical position of the channel, for example, at the uppermost stream part of the channel, or they may be connected at positions shifted from each other.

In the invention, each supply portion includes the supply channel, and the heating means for heating the fluid to-be-treated flowing through the supply channel, so that the temperature of the fluid to-be-treated flowing through the supply channel can be controlled by heating the fluid to-be-treated. By controlling the temperature of the fluid to-be-treated, the viscosity of the fluid to-be-treated can be controlled, and the flow velocity of the fluid to-be-treated flowing through the supply channel can be controlled. Thus, it is possible to control the supply quantity per unit time, of the fluid to-be-treated which is supplied to the channel by the supply portion. Accordingly, in a case, for example, where the plurality of fluids to-be-treated are mixed and chemically reacted to obtain a reaction product, the respective fluids to-be-treated can be mixed and chemically reacted in the optimum supply quantities per unit time, so that the reaction product can be obtained at a high yield.

Besides, in the invention it is preferable that the base further includes a collection portion connected to the channel and from which the treated fluid is drawn to the outside, and that the plurality of fluids to-be-treated are respectively caused to flow from the plurality of supply portions into the channel, the plurality of fluids to-be-treated caused to flow in are merged to be subjected to the predetermined treatment, and thereafter the treated fluid is drawn from the collection portion to the outside.

According to the invention, the plurality of fluids to-be-treated which are respectively caused to flow from the plurality of supply portions into the channel are mixed and chemically reacted in the optimum supply quantities per unit time, thereby to obtain the reaction product, and the obtained reaction product is drawn from the collection portion to the outside. Accordingly, it is possible to fabricate, for example, a small-sized microchemical chip which has two supply portions, in which a compound serving as a raw material is caused to flow in from one supply portion, while a reagent is caused to flow in from the other supply portion, the compound and the reagent are sufficiently mixed and chemically reacted, and thereafter the obtained compound can be taken out of the collection portion.

Besides, in the invention it is preferable that the base further includes a heating treatment portion for heating the merged fluids to-be-treated and performing the predetermined treatment thereto, the heating treatment portion being disposed on a downstream side in a flowing direction of the fluids to-be-treated with respect to a position where the supply portions and the channel are connected.

According to the invention, the plurality of fluids to-be-treated respectively caused to flow from the plurality of supply portions into the channel are mixed in the optimum supply quantities per unit time, and they are thereafter heated and chemically reacted in the heating treatment portion, whereby the reaction product is obtained. For example, in a case where two supply portions are provided, a compound serving as a raw material is caused to flow in from one supply portion, while a reagent is caused to flow in from the other supply portion, and the compound and the reagent are merged and are heated in the treatment portion, thereby to be reacted, the compound and the reagent can be heated in a state where they are sufficiently mixed, so that the compound and the reagent can be efficiently reacted to enhance the yield of the reaction product.

Besides, the invention provides a microchemical chip comprising:
a base including a channel for causing fluids to-be-treated to flow therethrough, a plurality of supply portions connected to the channel, for causing the plurality of fluids to-be-treated to flow into the channel, respectively, and a heating treatment portion for heating the merged fluids to-be-treated and performing a predetermined treatment thereto, the heating treatment portion being disposed on a downstream side in a flowing direction of the fluids to-be-treated with respect to a position where the supply portions and the channel are connected, the plurality of fluids to-be-treated being respectively caused to flow from the plurality of supply portions into the channel, and the plurality of fluids to-be-treated caused to flow in being merged to be subjected to the predetermined treatment,
wherein the channel includes, between the heating treatment portion and the position where the supply portions are connected, an enlarged portion having a cross-sectional area larger than each of those of upstream and downstream channel parts.

According to the invention, when the fluids to-be-treated are caused to flow in from the plurality of supply portions, the fluids to-be-treated caused to flow in are merged and caused to flow through the channel, and they are heated in the heating treatment portion, whereby the predetermined treatment is performed. Accordingly, when the plurality of different fluids to-be-treated are respectively caused to flow in from the plurality of supply portions, the plurality of fluids to-be-treated caused to flow in are merged and caused to flow through the channel, whereby the predetermined treatment is performed. The plurality of supply portions and the channel may be connected at the identical position of the channel, for example, at the uppermost stream part of the channel, or they may be connected at positions shifted from each other.

In the invention, between the heating treatment portion and the position where the supply portions are connected, the channel includes the enlarged portion having the cross-sectional area larger than each of those of the upstream and downstream channel parts. Therefore, a flow rate variation caused by a temperature change in the heating treatment portion is absorbed by the enlarged portion, and the reactivity of the plurality of mixed fluids to-be-treated can be prevented from degrading due to the flow rate variation thereof. More specifically, when a temperature in the heating treatment portion has changed, the volume of the plurality of mixed fluids to-be-treated changes, but the volumetric change is absorbed by the enlarged portion. Therefore, the flow rate of the fluids to-be-treated which flow through the channel does not change, and the reactivity in the heating treatment portion can be prevented from degrading. Especially in a case where the volume of the plurality of mixed fluids to-be-treated has increased on account of a temperature rise, the increased volume is absorbed by the enlarged portion, and hence, the flow rate does not decrease due to, for example, the backward flow of the fluids to-be-treated flowing through the channel, so that the reactivity in the heating treatment portion can be prevented from degrading. Moreover, since the reactivity in the heating treatment portion does not degrade, the microchemical chip which affords a high yield to the reaction product can be realized.

Besides, in the invention it is preferable that a length of the enlarged portion is 3 to 10 mm.

Besides, in the invention it is preferable that a cross-sectional area of the enlarged portion is at least 1.5 times as large as each of cross-sectional areas of the upstream and downstream channel parts.

According to the invention the length of the enlarged portion is made 3 to 10 mm, and/or the cross-sectional area of the enlarged portion is made at least 1.5 times as large as each of the cross-sectional areas of the upstream and downstream channel parts, whereby the absorption of the flow rate variation caused by the temperature change can be reliably executed in the heating treatment portion, and the reactivity of the plurality of mixed fluids to-be-treated can be reliably prevented from degrading on account of the flow rate variation.

Besides, in the invention it is preferable that the base further includes a collection portion connected to the channel on the downstream side in the flowing direction of the fluids to-be-treated with respect to the heating treatment portion, from which the treated fluid is drawn to the outside, and that the plurality of fluids to-be-treated are respectively caused to flow from the plurality of supply portions into the channel, the plurality of fluids to-be-treated caused to flow in are merged, heated in the heating treatment portion and subjected to the predetermined treatment, and thereafter the treated fluid is drawn from the collection portion to the outside.

According to the invention, the plurality of fluids to-be-treated which are respectively caused to flow from the plurality of supply portions into the channel are merged, then heated in the heating treatment portion and subjected to the predetermined treatment, and thereafter the treated fluid is drawn from the collection portion to the outside. Accordingly, it is possible to obtain, for example, a microchemical chip which has two supply portions, in which a compound serving as a raw material is caused to flow in from one supply portion, while a reagent is caused to flow in from the other supply portion, and in which the obtained compound can be taken out of the collection portion after the compound and the reagent have been sufficiently mixed and reacted.

The invention provides a microchemical chip comprising:
a base including a channel for causing fluids to-be-treated to flow therethrough, a plurality of supply portions connected to the channel, for causing the plurality of fluids to-be-treated to flow into the channel, respectively, and a heating treatment portion for heating the merged fluids to-be-treated and performing the predetermined treatment thereto, the heating treatment portion being disposed on a downstream side in a flowing direction of the fluids to-be-treated with respect to a position where the supply portions and the channel are connected, the plurality of fluids to-be-treated being respectively caused to flow from the plurality of supply portions into the channel, and the plurality of fluids to-be-treated caused to flow in being merged to be subjected to a predetermined treatment,
wherein the base further includes a heat radiation portion for emitting heat generated from the heating treatment portion out of the base.

Besides, in the invention it is preferable that the base includes a plurality of heating treatment portions.

According to the invention, when the fluids to-be-treated are caused to flow in from the plurality of supply portions, the fluids to-be-treated caused to flow in are merged and caused to flow through the channel, and they are heated in the respective heating treatment portions, whereby the chemical reactions proceed. Accordingly, when the plurality of different fluids to-be-treated are respectively caused to flow in from the plurality of supply portions, the plurality of fluids to-be-treated caused to flow in are merged and caused to flow through the channel, and they are chemically reacted in the respective heating treatment portions, whereby the reaction product is produced. The plurality of supply portions and the channel may be connected at the identical position of the channel, for example, at the most upstream part of the channel, or they may be connected at positions shifted from each other.

In the invention, the base includes the heat radiation portion for emitting heat generated from the heating treatment portions out of the base, so that influence which the heat from each of the heating treatment portions exerts on the other can be suppressed, and a precise temperature control in each of the heating treatment portions becomes possible. Therefore, in a case where a reaction product is to be produced by performing chemical reactions requiring heating, a plurality of times, each of the chemical reactions proceeds satisfactorily, and the desired reaction product can be obtained at a high yield.

Besides, in the invention it is preferable that the heat radiation portion is composed of a heat radiation plate arranged in contact with a surface of the base, the heat radiation plate being made of a material having a thermal conductivity higher than that of the base.

According to the invention, the heat radiation plate which is made of the material having the thermal conductivity higher than that of the base is arranged in contact with the surface of the base, so that the heat conducted from the heating treatment portions to the surroundings is emitted out of the heat radiation plate. Besides, since the heat radiation portion is constructed merely by arranging the heat radiation plate, it can be constructed with ease. By the way, in order to heighten its close adhesion with the base, the heat radiation plate is preferably fixed to the base with a binder the thermal conductivity of which is higher than that of the base.

Besides, in the invention it is preferable that the heat radiation portion has penetrating holes in regions which oppose to parts of the surface of the base close to the heating treatment portions.

According to the invention, the heat radiation plate is employed which has the penetrating holes in the regions opposing to the surface parts of the base close to the heating treatment portions. Therefore, heat emission from the front surface parts of the base close to the heating treatment portions is suppressed, and heat conducted from the heating treatment portions to the surroundings is emitted out of the base by the heat radiation plate, so that the influence which the heat from each of the heating treatment portions exerts on the other can be suppressed. In each of the heating treatment portions, accordingly, sufficient heat can be ensured without being influenced by the other heating treatment portion, so that a temperature suitable for the chemical reaction can be kept. Thus, the reaction product can be produced at the high yield.

Besides, in the invention it is preferable that the heat radiation portion is composed of a groove formed in a region of the base as lies between the plurality of heating treatment portions.

According to the invention, since the groove is formed in the region between the heating treatment portions, heat conducted in a direction from each of the heating treatment portions toward the other is emitted out of the base from the wall surface/surfaces and bottom surface of the groove. Moreover, since the heat radiation portion is constructed by forming the groove in the base itself, the microchemical chip can be made smaller in construction and lighter in weight than in the case of employing a separate component such as the heat radiation plate.

Besides, in the invention it is preferable that the heating treatment portion includes a heater, and that the heat radiation portion has a heat radiation plate having an external size smaller than that of the heater and an external shape similar to that of the heater which heat radiation plate is arranged in a region facing the heater on a surface of the base close to the heater.

According to the invention, the heat radiation plate which has the external size smaller than that of the heater and the external shape similar to that of the heater is arranged in the region opposing to the heater on the surface of the base close to the heater. Therefore, the temperature difference between the central part and outer peripheral parts of the heater can be made small, with the result that the temperature of the reaction portion can be controlled uniformly and precisely.

In the invention it is preferable that an area of the heat radiation plate as viewed in plan reaches 50 to 90% of an area of the heater as viewed in plan.

According to the invention, the area of the heat radiation plate as viewed in plan should preferably be 50 to 90% of the area of the heater as viewed in plan. Therefore, the temperature difference between the central part and outer peripheral parts of the heater can be made still smaller, with the result that the temperature of the reaction portion can be controlled more uniformly and more precisely.

Besides, in the invention it is preferable that the base further includes a collection portion connected to the channel and from which the treated fluid is drawn to the outside, and that the reaction product is drawn from the collection portion to the outside.

According to the invention, the plurality of fluids to-be-treated respectively caused to flow from the plurality of supply portion into the channel are mixed and chemically reacted to obtain the reaction product, and the obtained reaction product is drawn from the collection portion to the outside. Accordingly, it is possible to fabricate, for example, a small-sized microchemical chip which has two supply portions, in which a compound serving as a raw material is caused to flow in from one supply portion, while a reagent is caused to flow in from the other supply portion, and in which the obtained compound can be taken out of the collection portion after the compound and the reagent have been sufficiently mixed and reacted.

### BRIEF DESCRIPTION OF THE DRAWINGS

Other and further objects, features, and advantages of the invention will be more explicit from the following detailed description taken with reference to the drawings wherein:

FIG. 1A is a simplified plan view showing the construction of a microchemical chip according to a first embodiment of the invention, and FIG. 1B is a sectional view showing the sectional constructions of the microchemical chip as are taken along cutting lines I-I, II-II and III-III indicated in FIG. 1A;

FIGS. 2A and 2B are plan views showing the states of the processed ceramic green sheets;

FIG. 3 is a fragmentary sectional view showing a state where the ceramic green sheets are laminated;

FIG. 4 is a simplified plan view showing the construction of a lid;

FIG. 5A is a simplified plan view showing the construction of a microchemical chip according to a second embodiment of the invention, and FIG. 5B is a sectional view showing the sectional constructions of the microchemical chip as are taken along cutting lines IV-IV, V-V and VI-VI indicated in FIG. 5A;

FIGS. 6A and 6B are views showing a shape of an enlarged portion, wherein FIG. 6A is a plan view, and FIG. 6B is a sectional view;

FIGS. 7A and 7B are views showing another shape of the enlarged portion, wherein FIG. 7A is a plan view, and FIG. 7B is a sectional view;

FIGS. 8A and 8B are views showing still another shape of the enlarged portion, wherein FIG. 8A is a plan view, and FIG. 8B is a sectional view;

FIGS. 9A and 9B are plan views showing the states of the processed ceramic green sheets;

FIG. 10 is a fragmentary sectional view showing a state where the ceramic green sheets are laminated;

FIG. 11 is a simplified plan view showing the construction of a lid;

FIG. 12A is a simplified plan view showing the construction of a microchemical chip according to a third embodiment of the invention, and FIG. 12B is a sectional view showing the sectional constructions of the microchemical chip as are taken along cutting lines VII-VII, VIII-VIII and IX-IX indicated in FIG. 12A;

FIGS. 13A and 13B are plan views showing plan views showing the states of the processed ceramic green sheets;

FIG. 14 is a fragmentary sectional view showing a state where the ceramic green sheets are laminated;

FIG. 15 is a simplified plan view showing the construction of a lid;

FIG. 16 is a plan view of a heat radiation plate;

FIG. 17A is a simplified plan view showing the construction of a microchemical chip according to a fourth embodiment of the invention, and FIG. 17B is a sectional view showing the sectional constructions of the microchemical chip as are taken along cutting lines X-X, XI-XI and XII-XII indicated in FIG. 17A;

FIG. 18A is a simplified plan view showing the construction of a microchemical chip according to a fifth embodiment of the invention, and FIG. 18B is a sectional view showing the sectional constructions of the microchemical chip as are taken along cutting lines XIII-XIII, XIV-XIV and XV-XV indicated in FIG. 18A; and

FIG. 19 is showing a microchemical chip according to a sixth embodiment of the invention, and is a plan view showing a shape of a heat radiation plate.

### DETAILED DESCRIPTION

Now referring to the drawings, preferred embodiments of the invention are described below.

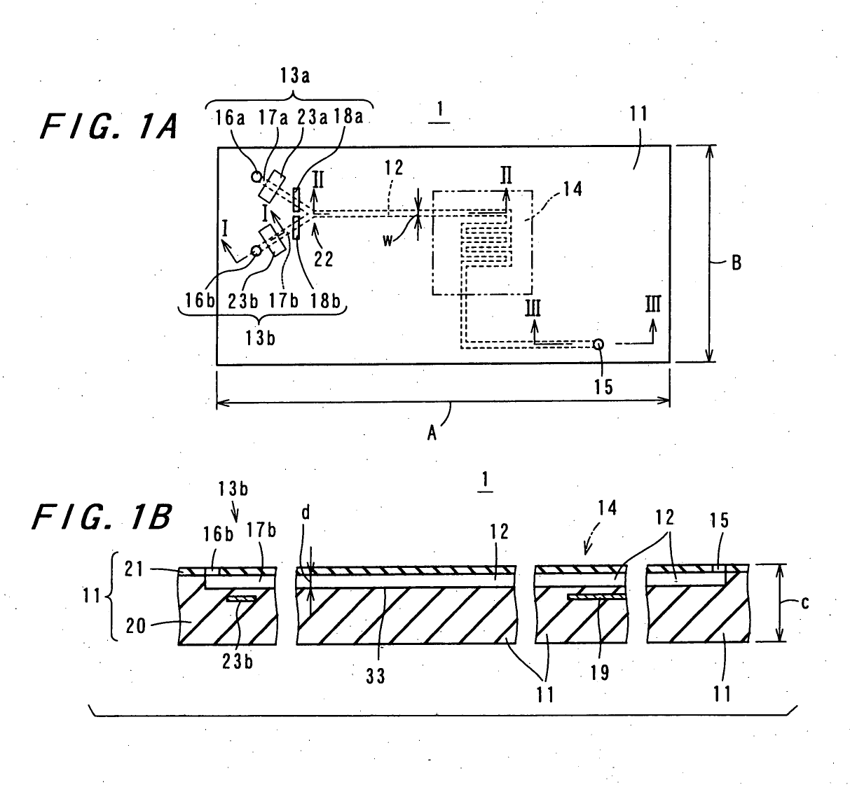

FIG. 1A is a simplified plan view showing the construction of a microchemical chip 1 according to a first embodiment of the invention, and FIG. 1B is a fragmentary sectional view showing the sectional constructions of the microchemical chip 1 as are taken along cutting lines I-I, II-II and III-III indicated in FIG. 1A. By the way, in FIG. 1B, the sectional constructions taken along the cutting plane lines I-I, II-II and III-III are shown in this order.

The microchemical chip 1 comprises a base 11 including a channel 12 for causing fluids to-be-treated to flow therethrough, two supply portions 13a and 13b for causing the fluids to-be-treated to flow therefrom into the channel 12, respectively, a heating treatment portion 14 for heating the mixed fluids to-be-treated and performing a predetermined treatment thereto, and a collection portion 15 from which the treated fluid is drawn to the outside. The base 11 includes a base body 20 having a groove portion 33 formed in one surface thereof, and a lid 21 which is a covering member. Thus, the channel 12 is defined in such a way that the surface of the base body 20 having the groove portion 33 is covered with the lid 21.

The supply portion 13a includes a supply channel 17a which is connected to the channel 12, a supply port 16a which is provided at an end part of the supply channel 17a, a micropump 18a which is provided on the upper stream side in the flowing direction of the fluid to-be-treated with respect to a connecting position 22 to the channel 12, and a heater 23a for heating the fluid to-be-treated flowing through the supply channel 17a. Likewise, the supply portion 13b includes a supply channel 17b, a supply port 16b, a micropump 18b, and a heater 23b. The supply ports 16a and 16b are opened such that a fluid to-be-treated can be poured into the supply channels 17a and 17b from the outside. The collection portion 15 is configured as an opening such that a treated fluid is removed from the channel 12 to the outside.

The heaters 23a and 23b are disposed below the respective supply channels 17a and 17b within the base body 20. Besides, a heater 19 is disposed within the base body 20 and at a part of the heating treatment portion 14 below the channel 12. The channel 12 in the heating treatment portion 14 is bent and formed in, for example, a zigzag shape so as to pass above the heater 19a plurality of times. Wiring lines (not shown) for connecting the heaters 19, 23a and 23b with an external power source are led out of these heaters 19, 23a and 23b onto the surface of the base 11. The wiring lines are formed of a metal material which has an electric resistance value lower than that of the material of the heaters 19, 23a and 23b.

In the microchemical chip 1, fluids to-be-treated are caused to flow from the two supply portions 13a and 13b into the channel 12 and are merged into one, and the channel 12 is heated at a predetermined temperature with the heater 19 in the heating treatment portion 14, if necessary, so that the two kinds of fluids to-be-treated caused to flow in are reacted, and then the obtained reaction product is drawn from the collection portion 15.

In this embodiment, the supply portions 13a and 13b are constructed including the supply channels 17a and 17b, and the heaters 23a and 23b which heat the fluids to-be-treated flowing through the supply channels 17a and 17b, respectively, so that temperatures can be controlled by heating the fluids to-be-treated which flow through the supply channels 17a and 17b. By controlling the temperature of the fluids to-be-treated, the viscosities of the fluids to-be-treated can be controlled, and the flow velocities of the fluids to-be-treated flowing through the supply channels 17a and 17b can be controlled. Thus, it is possible to control the supply quantities per unit time, of the fluids to-be-treated which the supply portions 13a and 13b supply to the channel 12. Accordingly, in a case, for example, where a reaction product is to be obtained by mixing and chemically reacting a plurality of fluids to-be-treated, the respective fluids to-be-treated can be mixed and chemically reacted in the optimum supply quantities per unit time, and hence, the reaction product can be obtained at a high yield.

The cross-section area of the channel 12 and the supply channels 17a and 17b is preferably 2.5×1⁻³ mm² or more and 1 mm² or less in order to effciently deliver and mix specimens, reagents, or cleaning liquids caused to flow in from the supply portions 13a and 13b. However, the fluid flowing through the channel having a cross-section area of about 2.5×10⁻³ mm² to 1 mm² generally flows in a state of a laminar flow, so that simply connecting the two supply channels 17a and 17b allows the two fluids that are caused to flow from the supply portions 13a and 13b into the channel 12 and merged to be mixed only by diffusion. Therefore, it is necessary to provide a long channel in order to mix the merged two fluids fully, which limits the achievement of a compact microchemical chip.

In this regard, an agitation portion for agitating the fluids to-be-treated may be formed on the downstream side in the flowing direction of the fluids to-be-treated with respect to the connection position 22 between the channel 12 and the supply portions 13a and 13b. The agitation portion may be incarnated by, for example, forming in the channel 12 an uneven portion having an uneven wall surface, a hydrophilic portion having a hydrophilic wall surface or a hydrophobic portion having a hydrophobic wall surface, arranging a vibration element for imparting vibrations to the fluids to-be-treated in the channel 12, or bending the channel 12. Thus, after the plurality of fluids to-be-treated have been merged, a turbulent flow is generated in the merged fluids to-be-treated by the agitation portion.

In this manner, the plurality of fluids to-be-treated can be mixed by generating the turbulent flow in the merged fluids to-be-treated. Thus, the plurality of fluids to-be-treated can be sufficiently mixed in a shorter channel in comparison with the case of mixing them by the diffusion only. Accordingly, the length of the channel 12 can be reduced. It is therefore possible to attain the reduction in the size of the microchemical chip 1, and to attain reduction in the size of a microchemical system employing the microchemical chip 1. Moreover, the predetermined treatment is performed in a state where the plurality of fluids to-be-treated are sufficiently mixed. Therefore, the predetermined treatment can be performed more reliably in comparison with the case where the mixing is insufficient.

Besides, by forming the agitation portion between the connecting position 22 and the heating treatment portion 14, the merged fluids to-be-treated have been sufficiently mixed in arriving at the heating treatment portion 14. Accordingly, for example, in a case where a compound serving as a raw material is caused to flow in from the supply portion 13a, where a reagent is caused to flow in from the supply portion 13b, and where the compound and the reagent are merged and are reacted by heating them with the heater 19 of the heating treatment portion 14, the compound and the reagent can be heated in a state where they have been sufficiently mixed. It is therefore possible to efficiently react the compound and the reagent, and to enhance the yield of a reaction product which is taken out of the collection portion 15.

As the base body 20, a base body made of a ceramic material, silicon, glass, or resin can be used, and among these, it is preferable to use a base body made of the ceramic material. The ceramic materials have excellent chemical resistance, compared with the resin or the like, so that when the base body 20 is made of a ceramic material, the microchemical chip 1 that has excellent chemical resistance and that can be used under various conditions can be obtained. Examples of the ceramic material constituting the base body 20 include an aluminum oxide sintered substance, a mullite sintered substance, or a glass ceramic sintered substance.

The lid 21 can be formed of glass or a ceramic material, but it is preferable to use glass for the lid 21 because the mixed state or the reaction state of the fluids to-be-treated can be visually confirmed.

The cross-section area of the channel 12 and the supply channels 17a and 17b is preferably 2.5×10⁻³ mm² or more and 1 mm² or less in order to efficiently deliver and mix specimens, reagents, or cleaning liquids poured from the supply portions 13a and 13b. When the cross-section area of the channel 12 and the supply channels 17a and 17b exceeds 1 mm², the amount of delivered specimen, reagent, or cleaning liquid becomes excessive, so that a reaction surface area per unit volume is increased, and therefore an effect of reducing the reaction time significantly of the microchemical chip cannot sufficiently be obtained. Furthermore, when the cross-section area of the channel 12 and the supply channels 17a and 17b is less than 2.5×10⁻³ mm², the loss of the pressure due to the micropumps 18a and 18b is increased, so that a problem is caused in delivering fluids. Therefore, it is preferable that the cross-section area of the channel 12 and the supply channels 27a and 27b is 2.5×10⁻³ mm² or more and 1 mm² or less.

The width w of the channel 12 and the supply channels 17a and 17b is preferably 50 to 1000 μm, more preferably 100 to 500 μm. The depth d of the channel 12 and the supply channels 17a and 17b is preferably 50 to 1000 μm, more preferably 100 to 500 μm, and within the preferable range of the cross-section area as described above. When the cross-sectional shapes of the channel 12 and the supply channels 17a and 17b are of a rectangular shape, the relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

The outline size of the microchemical chip 1 is, for example, such that the width A is about 40 mm, the depth B is about 70 mm, and the height C is about 1 to 2 mm, but the invention is not limited thereto, and an appropriate outline size can be used, depending on the necessity.

The microchemical chip 1 after use can be used again when the microchemical chip is cleaned by pouring a cleaning liquid from the supply portions 13a and 13b.

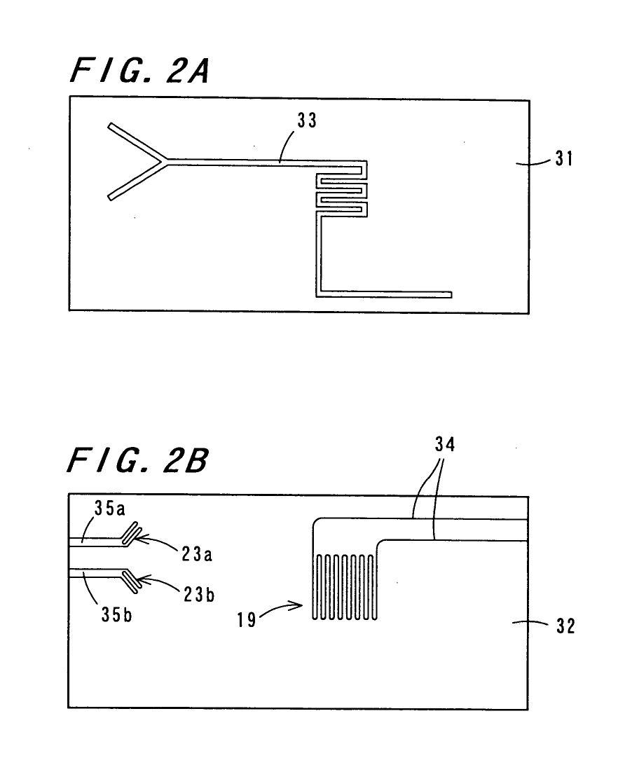

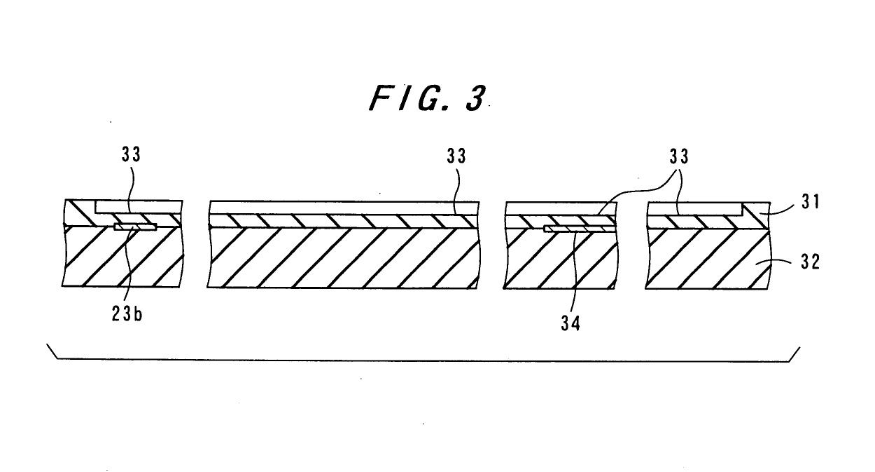

Next, a method of manufacturing the microchemical chip 1 shown in FIGS. 1A and 1B will be described. This embodiment shall be described about a case where the base body 20 is made of a ceramic material. FIGS. 2A and 2B are plan views showing the states of the processed ceramic green sheets 31 and 32, respectively. FIG. 3 is a sectional view showing a state where the ceramic sheets 31 and 32 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the base body 20 is made of an aluminum oxide sintered substance, aluminum oxide, silicon oxide, magnesium oxide, and calcium oxide or the like can be used.

In this embodiment, two of the thus formed ceramic green sheets are used to form the base body 20. First, as shown in FIG. 2A, the groove portion 33 is formed by pressing the surface of the first ceramic green sheet 31 with a pattern. In this case, a pattern having a shape to which desired shape of the groove portion 33 is transferred is used. Incidentally, by using a pattern in which an uneven shape is transferred on a portion corresponding to a predetermined wall surface part, as the shape of the groove portion, unevenness can be formed on a wall surface part of the groove portion which constitutes the uneven portion serving as the agitation portion stated before.

The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 2B, the heaters 19, 23a and 23b and wiring patterns 34, 35a and 35b for external power connection are formed on the surface of the ceramic green sheet 32 by applying a conductive paste in a predetermined shape by screen printing or the like. The wiring patterns 35a and 35b constituting the heaters 23a and 23b are bent and formed in, for example, a zigzag shape so as to pass below supply channels 17a and 17b a plurality of times at their parts corresponding to these supply channels 17a and 17b, respectively. Also, the wiring pattern constituting the heater 19 is bent and formed in, for example, a zigzag shape at its part corresponding to the heating treatment portion 14. The conductive paste can be obtained by mixing a metal material powder such as tungsten, molybdenum, manganese, copper, silver, nickel, palladium, or gold with a suitable organic binder and solvent. For the conductive paste which forms the wiring patterns 34, 35a and 35b constituting the respective heaters 19, 23a and 23b, a conductive paste in which 5 to 30 wt % of a ceramic powder is added to a metal material powder as described above such that a predetermined electric resistance value is achieved after firing is used.

As shown in FIG. 3, the ceramic green sheet 31 in which the groove portion 33 is formed is laminated on the surface of the ceramic green sheet 32 in which the wiring patterns 34, 35a and 35b constituting the heaters 19, 23a and 23b are formed. The laminated ceramic green sheets 31 and 32 are sintered at a temperature of about 1600° C. Thus, the base body 20 shown in FIGS. 1A and 1B is formed in which the heaters 23a and 23b for heating the fluids to-be-treated flowing through the supply channels 17a and 17b of the supply portions 13a and 13b, respectively.

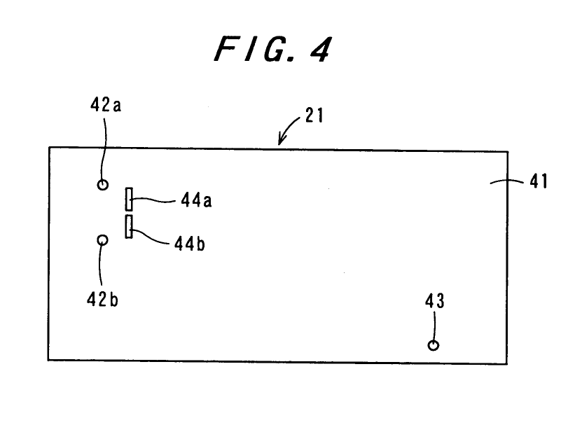

FIG. 4 is a plan view showing a simplified structure of the lid 21. As shown in FIG. 4, the through-holes 42a, 42b and 43 that are in communication with the groove portion 33 of ceramic green sheet 31 shown in FIG. 2A are formed in the predetermined positions that are to serve as the supply ports 16a and 16b and the collection portion 15 in a substrate 41 made of, for example, glass or a ceramic material, and thus the lid 21 can be obtained.

The lid 21 is bonded onto the surface on which the groove portion 33 is exposed of the base body 20. For example, the lid 21 and the base body 20 are bonded by heating and pressing when the lid 21 is made of glass, and are bonded with a glass adhesive when the lid 21 is made of a ceramic material.

Piezoelectric materials 44a and 44b such as lead zirconate titanate (PZT; composition formula: Pb(Zr, Ti)O₃) are attached into predetermined positions on the surface of the lid 21, and conduction lines (not shown) for applying a voltage to the piezoelectric materials 44a and 44b are formed.

The piezoelectric materials 44a and 44b can vibrate the lid 21 above the supply channels 17a and 17b by expanding or contracting in accordance with the applied voltage, and therefore micropumps 18a and 18b for delivering fluids can be formed by attaching the piezoelectric materials 44a and 44b to the lid 21 above the supply channels 17a and 17b.

In the manner described above, the base 11 shown in FIGS. 1A and 1B is formed so that the microchemical chip 1 can be obtained. Thus, the microchemical chip 1 in which the heaters 23a and 23b for heating the fluids to-be-treated flowing through the respective supply channels 17a and 17b of the supply portions 13a and 13b are formed can be manufactured by bonding the lid 21 onto the base body 20 in which the heaters 23a and 23b for heating the fluids to-be-treated flowing-through the respective supply channels 17a and 17b of the supply portions 13a and 13b are formed.

In this embodiment, the base body 20 is formed by sintering the laminated structure which consists of the ceramic green sheet 31 in a surface of which the groove portion 33 is formed by pressing with a pattern, and the ceramic green sheet 32 in which the wiring patterns 34, 35a and 35b constituting the respective heaters 19, 23a and 23b are formed, whereupon the base 11 having the channel 12 is formed by covering the groove portion 33 in the surface of the base body 20 with the lid 21. Therefore, the microchemical chip 1 can be produced only by simple processing without performing complicated processing such as etching processing that is necessary when forming a channel in the base 11 made of silicon, glass or resin.

In the invention, in addition to the heaters 23a and 23b, cooling means formed of, for example, an electrothermal element such as thermocouple or Peltier element may be provided for, for example, the channel 12. In this case, the flow velocities of the fluids to-be-treated can be controlled at a higher precision by disposing the cooling means for the channel 12 which lies on the downstream sides of the heaters 23a and 23b.

Besides, the heating treatment portion 14 (heater 19) is constructed as being provided in one place, but such heating treatment portions (heaters) may be disposed in two or more places without being restricted to the exemplary construction. A complicated reaction can be controlled by disposing the three or more supply portions, and the heating treatment portions (heaters) in the two or more places in this manner. Incidentally, the heating treatment portion 14 (heater 19) need not be provided in such a case where a reaction proceeds without heating.

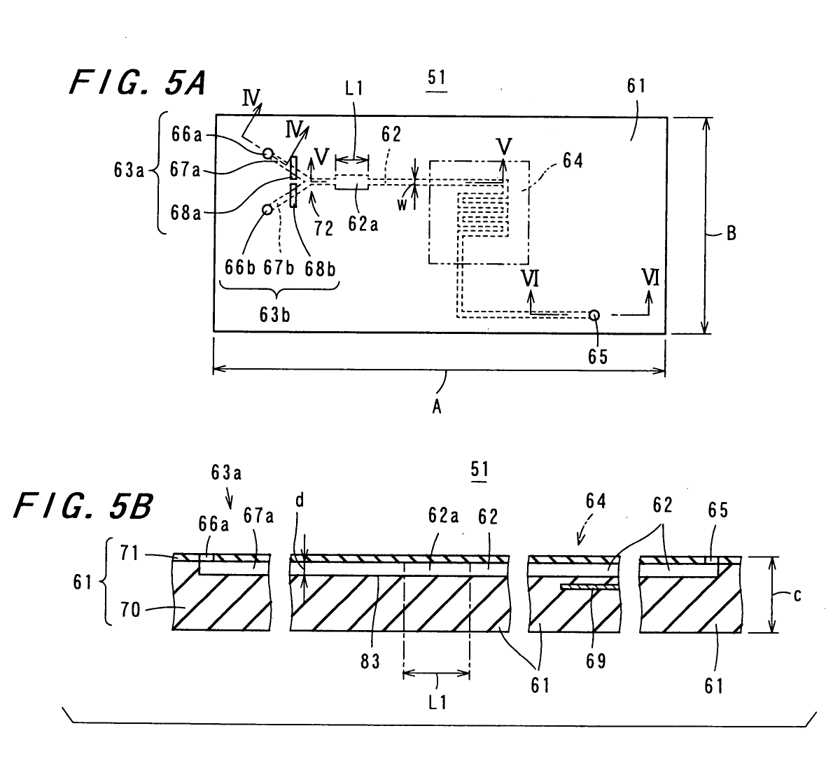

FIG. 5A is a simplified plan view showing the construction of a microchemical chip 51 according to a second embodiment of the invention, and FIG. 5B is a fragmentary sectional view showing the sectional constructions of the microchemical chip 51 as are taken along cutting lines IV-IV, V-V and VI-VI indicated in FIG. 5A. By the way, in FIG. 5B, the sectional constructions taken along the cutting lines. IV-IV, V-V and VI-VI are shown in this order.

The microchemical chip 51 comprises a base 61 including a channel 62 for causing fluids to-be-treated to flow therethrough, two supply portions 63a and 63b for causing the fluids to-be-treated to flow therefrom into the channel 62, respectively, a heating treatment portion 64 for heating the two mixed fluids to-be-treated and performing a predetermined treatment thereto, and a collection portion 65 from which the treated fluid is drawn to the outside. The base 61 includes a base body 70 having a groove portion 83 in one surface thereof, and a lid 71 which is a covering member. Thus, the channel 62 is defined in such a way that the surface of the base body 70 having the groove portion 83 is covered with the lid 71.

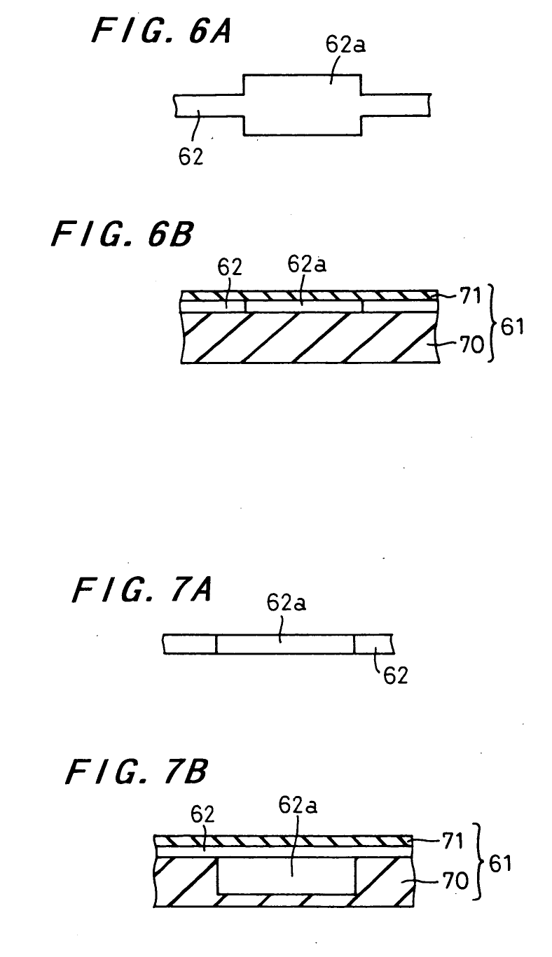

In the microchemical chip 51, the channel 62 has an enlarged portion 62a the cross-sectional area of which is larger than each of those of upstream and downstream channel parts, between the heating treatment portion 64 and a connecting position 72 of the supply portions 63a and 63b. FIGS. 6A and 6B are views showing the shape of the enlarged portion 62a, wherein FIG. 6A is a plan view, and FIG. 6B is a sectional view. As shown in FIGS. 6A and 6B, the enlarged portion 62a is formed in such a way that, in the channel 62 whose sectional shape is a rectangle, the width of the pertinent part is made larger than each of the widths of the upstream and downstream channel parts.

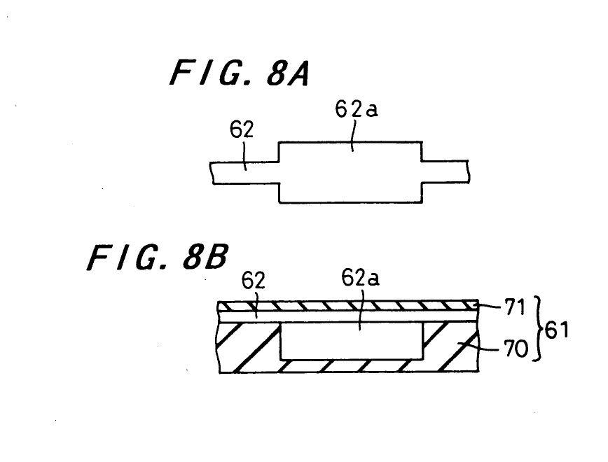

Alternatively, the enlarged portion 62a may be formed in such a way that, as shown in FIGS. 7A and 7B, the depth of the pertinent part is made larger than each of the depths of the upstream and downstream channel parts in the channel 62 of rectangular sectional shape, or in such a way that, as shown in FIGS. 8A and 8B, both the width and depth of the pertinent part are made larger than each of the widths and each of the depths of the upstream and downstream channel parts in the channel 62 of rectangular sectional shape.

The supply portion 63a includes a supply channel 67a which is connected to the channel 62, a supply port 66a which is provided at an end part of the supply channel 67a and a micropump 68a which is provided on the upper stream side in the flowing direction of the fluid to-be-treated with respect to a connecting position 72 to the channel 62. Likewise, the supply portion 63b includes a supply channel 67b, a supply port 66b and a micropump 68b. The supply ports 66a and 66b are opened such that a fluid to-be-treated can be poured into the supply channels 67a and 67b from the outside. The collection portion 65 is configured as an opening such that a treated fluid is removed from the channel 62 to the outside.

A heater 69 is disposed within the base body 70 and at a part of the heating treatment portion 64 below the channel 62. The channel 62 in the heating treatment portion 64 is bent and formed in, for example, a zigzag shape so as to pass above the heater 69 a plurality of times. A wiring line (not shown) for connecting the heater 69 with an external power source is led out of the heater 69 onto the surface of the base 61. The wiring line is formed of a metal material which has an electric resistance value lower than that of the material of the heater 69.

In the microchemical chip 51, fluids to-be-treated are caused to flow from the two supply portions 63a and 63b into the channel 62 and are merged into one, and the channel 62 is heated at a predetermined temperature with the heater 69 in the heating treatment portion 64, if necessary, so that the two kinds of fluids to-be-treated caused to flow in are reacted, and then the obtained reaction product is drawn from the collection portion 65.

As the first embodiment, the cross-section area of the channel 62 and the supply channels 67a and 67b is preferably 2.5×10⁻³ mm² or more and 1 mm² or less in order to efficiently deliver and mix specimens, reagents, or cleaning liquids caused to flow in from the supply portions 63a and 63b.

In this embodiment, the channel 62 has the enlarged portion 62a between the connecting position 72 and the treatment portion 64. Therefore, a flow rate variation caused by a temperature change in the heating treatment portion 64 is absorbed by the enlarged portion 62a, and the reactivity of the plurality of mixed fluids to-be-treated can be prevented from degrading due to the flow rate variation thereof. More specifically, when a temperature in the heating treatment portion 64 has changed, the volume of the plurality of mixed fluids to-be-treated changes, but the volumetric change is absorbed by the enlarged portion 62a. Therefore, the flow rate of the fluids to-be-treated which flow through the channel 62 does not change, and the reactivity in the heating treatment portion 64 can be prevented from degrading. Especially in a case where the volume of the plurality of mixed fluids to-be-treated has increased on account of a temperature rise, the increased volume is absorbed by the enlarged portion 62a, and hence, the flow rate does not decrease due to, for example, the backward flow of the fluids to-be-treated flowing through the channel 62, so that the reactivity in the heating treatment portion 64 can be prevented from degrading. Moreover, since the reactivity in the heating treatment portion 64 does not degrade, the microchemical chip 51 which affords a high yield to the reaction product can be realized.

The length L1 of the enlarged portion 62a is preferably 3 to 10 mm. Besides, the cross-sectional area of the enlarged portion 62a is preferably 1.5 to 10 times, more preferably, 1.5 to 2 times, the cross-sectional area of each of the upstream and downstream channel parts.

As the base body 70, a base body made of a ceramic material, silicon, glass, or resin can be used, and among these, it is preferable to use a base body made of the ceramic material, as the first embodiment.

As the first embodiment, the lid 71 can be formed of glass or a ceramic material, but it is preferable to use glass for the lid 71 because the mixed state or the reaction state of the fluids to-be-treated can be visually confirmed.

For the same reason as the first embodiment, the cross-section area of the channel 62 and the supply channels 67a and 67b is preferably 2.5×10⁻³ mm² or more and 1 mm² or less in order to efficiently deliver and mix specimens, reagents, or cleaning liquids poured from the supply portions 63a and 63b.

As the first embodiment, the width w of the channel 62 and the supply channels 67a and 67b is preferably 50 to 1000 μm, more preferably 100 to 500 μm. As the first embodiment, the depth d of the channel 62 and the supply channels 67a and 67b is preferably 50 to 1000 μm, more preferably 100 to 500 μm, and within the preferable range of the cross-section area as described above. As the first embodiment, when the cross-sectional shapes of the channel 62 and the supply channels 67a and 67b are of a rectangular shape, the relationship between the width (longer side) and the depth (shorter side) is preferably the length of the shorter side/the length of the longer side >0.4, more preferably the length of the shorter side/the length of the longer side ≧0.6. When the length of the shorter side/the length of the longer side <0.4, the pressure loss is large, which causes a problem in delivering fluids.

The outline size of the microchemical chip 51 is, for example, such that the width A is about 40 mm, the depth B is about 70 mm, and the height C is about 1 to 2 mm, but the invention is not limited thereto, and an appropriate outline size can be used, depending on the necessity.

The microchemical chip 51 after use can be used again when the microchemical chip is cleaned by pouring a cleaning liquid from the supply portions 63a and 63b.

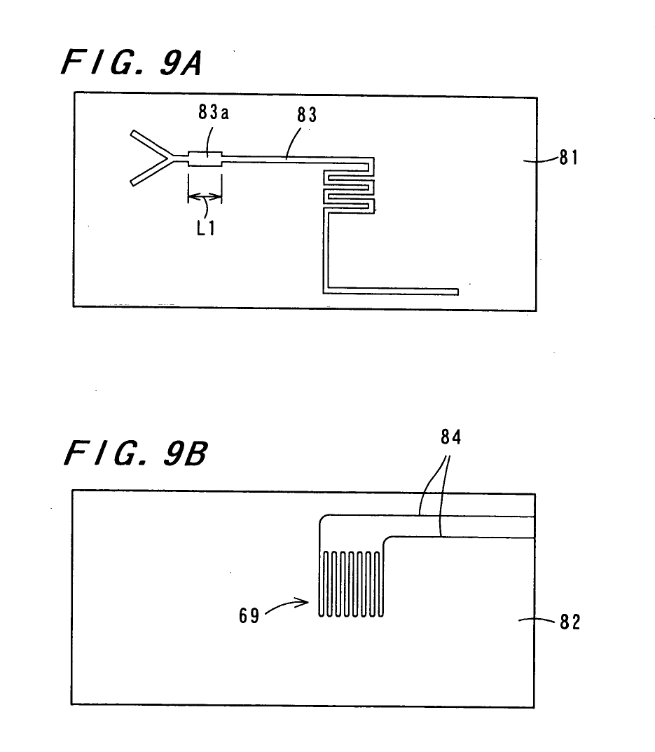

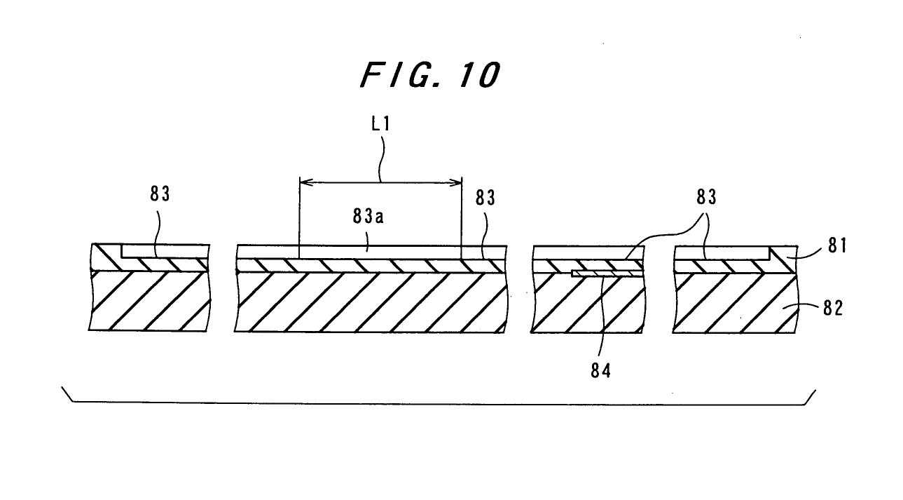

Next, a method of manufacturing the microchemical chip 51 shown in FIGS. 5A and 5B will be described. This embodiment shall be described about a case where the base body 70 is made of a ceramic material. FIGS. 9A and 9B are plan views showing the states of the processed ceramic green sheets 81 and 82, respectively. FIG. 10 is a sectional view showing a state where the ceramic sheets 81 and 82 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the base body 70 is made of an aluminum oxide sintered substance, aluminum oxide, silicon oxide, magnesium oxide, and calcium oxide or the like can be used.

In this embodiment, two of the thus formed ceramic green sheets are used to form the base body 70. First, as shown in FIG. 9A, groove portion 83 is formed by pressing the surface of the first ceramic green sheet 81 with a pattern. In this case, a pattern having a shape to which desired shape of the groove portion 83 is transferred is used. Further, in the pattern, a shape which corresponds to a broader portion 83a constituting the enlarged portion 62a is transferred as the shape of the groove portion. The groove portion 83 which has the broader portion 83a constituting the enlarged portion 62a can be formed using the pattern of such a shape.

The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 9B, the heater 69 and a wiring pattern 84 for external power connection are formed on the surface of the ceramic green sheet 82 by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste which forms the wiring pattern 84 constituting the heater 69, a conductive paste in which 5 to 30 wt % of a ceramic powder is added to a metal material powder as described above such that a predetermined electric resistance value is achieved after firing is used.

As shown in FIG. 10, the ceramic green sheet 81 in which the groove portion 83 is formed is laminated on the surface of the ceramic green sheet 82 in which the wiring pattern 84 constituting the heater 69 is formed. The laminated ceramic green sheets 81 and 82 are sintered at a temperature of about 1600° C. In the above way, the base body 70 shown in FIGS. 5A and 5B wherein the groove portion 83 having the portion constituting the enlarged portion between the heating treatment portion 64 and the connecting position 72 where the supply portions 63a and 63b and the channel 62 are connected, namely the broader portion is formed.

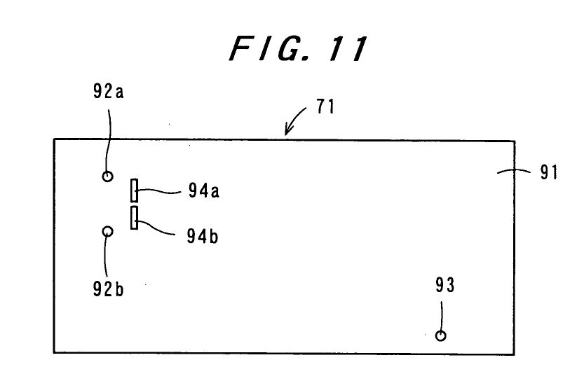

FIG. 11 is a plan view showing a simplified structure of the lid 71. As shown in FIG. 11, the through-holes 92a, 92b and 93 that are in communication with the groove portion 83 of ceramic green sheet 81 shown in FIG. 9A are formed in the predetermined positions that are to serve as the supply ports 66a and 66b and the collection portion 65 in a substrate 91 made of, for example, glass or a ceramic material, and thus the lid 71 can be obtained.

The lid 71 is bonded onto the surface on which the groove portion 83 is exposed of the base body 70. For example, the lid 71 and the base body 70 are bonded by heating and pressing when the lid 71 is made of glass, and are bonded with a glass adhesive when the lid 71 is made of a ceramic material.

Piezoelectric materials 94a and 94b such as lead zirconate titanate (PZT; composition formula: Pb(Zr, Ti)O₃) are attached into predetermined positions on the surface of the lid 71, and conduction lines. (not shown) for applying a voltage to the piezoelectric materials 94a and 94b are formed. The piezoelectric materials 94a and 94b can vibrate the lid 71 above the supply channels 67a and 67b by expanding or contracting in accordance with the applied voltage, and therefore micropumps 68a and 68b for delivering fluids can be formed by attaching the piezoelectric materials 94a and 94b to the lid 71 above the supply channels 67a and 67b.

In the manner described above, the base 61 shown in FIGS. 5A and 5B is formed so that the microchemical chip 51 can be obtained. Thus, the microchemical chip 51 in which the enlarged portion 62a is disposed between the heating treatment portion 64 and the connecting position 72 of the supply portions 63a and 63b can be manufactured by bonding the lid 71 onto the base body 70 in which the groove portion 83 having the broader portion 83a constituting the enlarged portion 62a between the heating treatment portion 64 and the connecting position 72 is formed.

In this embodiment, the base body 70 is formed by sintering the laminated structure which consists of the ceramic green sheet 81 in a surface of which the groove portion 83 is formed by pressing with a pattern, and the ceramic green sheet 82 in which the wiring pattern 84 constituting the heater 69 is formed, whereupon the base 61 having the channel 62 is formed by covering the groove portion 83 in the surface of the base body 70 with the lid 71. Therefore, the microchemical chip 51 can be produced only by simple processing without performing complicated processing such as etching processing that is necessary when forming a channel in the base 61 made of silicon, glass or resin.

A plurality of enlarged portions 62a in the invention may be provided with respect to one channel 62. Besides, the shape of the enlarged portion 62a as viewed in plan is not restricted to a tetragonal shape as shown in FIGS. 6A and 6B, but it can be made a curved shape such as circular, elliptical or oval shape. In this case, when the fluids to-be-treated have undergone a volumetric expansion in the enlarged portion 62a and applied a pressure to the inside surface of this enlarged portion 62a, the pressure can be reduced. Further, the shape of the enlarged portion 62a as viewed in plan should preferably be of the circular shape, the elliptical shape, the oval shape or the like curved shape in which this enlarged portion 62a smoothly joins to the channel 62. In this case, the flow of the fluids to-be-treated can be prevented from stagnating in the enlarged portion 62a.

Besides, the heating treatment portion 64 is constructed as being provided in one place, but such heating treatment portions may be disposed in two or more places without being restricted to the exemplary construction. A complicated reaction can be controlled by disposing the three or more supply portions, and the heating treatment portions in the two or more places in this manner. In the case where the plurality of heating treatment portions 64 are disposed, enlarged portions may be formed for the respective heating treatment portions 64 on the upstream side in the flowing direction of the fluids to-be-treated.

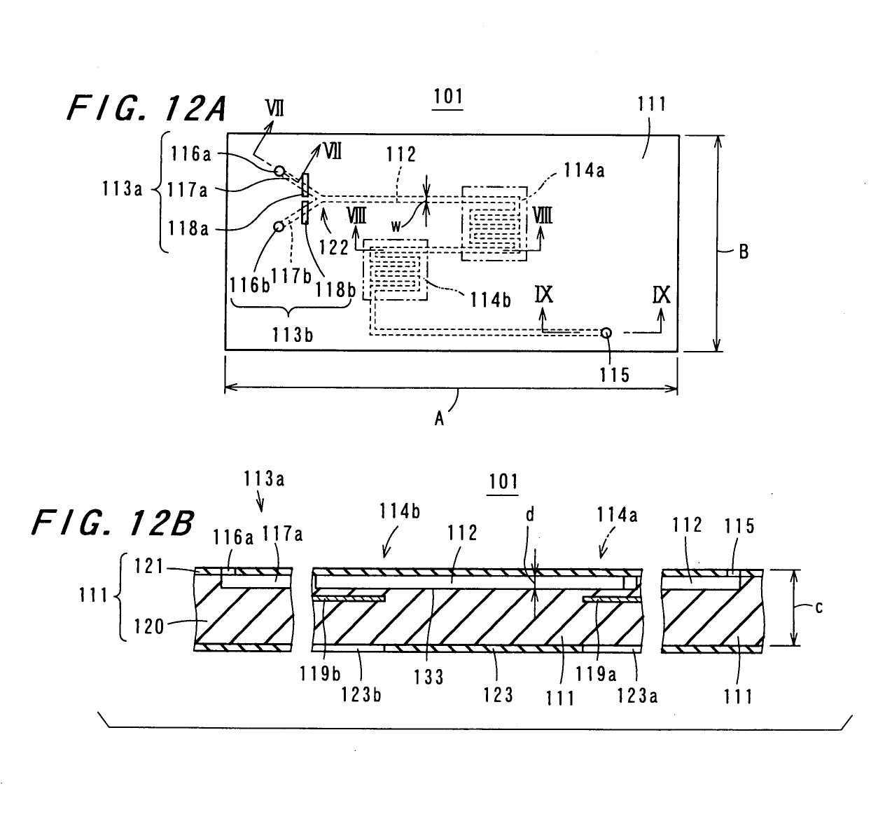

FIG. 12A is a simplified plan view showing the construction of a microchemical chip 101 according to a third embodiment of the invention, and FIG. 12B is a fragmentary sectional view showing the sectional constructions of the microchemical chip 101 as are taken along cutting lines VII-VII, VIII-VIII and IX-IX indicated in FIG. 12A. By the way, in FIG. 12B, the sectional constructions taken along the cutting lines VII-VII, VIII-VIII and IX-IX are shown in this order.

The microchemical chip 101 comprises a base 111 including a channel 112 for causing fluids to-be-treated to flow therethrough, two supply portions 113a and 113b for causing the fluids to-be-treated to flow therefrom into the channel 112, respectively, heating treatment portions 114a and 114b each for heating the mixed fluids to-be-treated and performing chemical reactions thereto, and a collection portion 115 from which the reacted fluid is drawn to the outside. The base 111 includes a base body 120 having a groove portion 133 in one surface thereof, and a lid 121 which is a covering member. Thus, the channel 112 is defined in such a way that the surface of the base body 120 having the groove portion 133 is covered with the lid 121.

The supply portion 113a includes a supply channel 117a which is connected to the channel 112, a supply port 116a which is provided at an end part of the supply channel 117a and a micropump 118a which is provided on the upper stream side in the flowing direction of the fluid to-be-treated with respect to a connecting position 122 to the channel 112. Likewise, the supply portion 113b includes a supply channel 117b, a supply port 116b and a micropump 118b. The supply ports 116a and 116b are opened such that a fluid to-be-treated can be poured into the supply channels 117a and 117b from the outside. The collection portion 115 is configured as an opening such that a treated fluid is removed from the channel 112 to the outside.

Heaters 119a and 119b are disposed within the base body 120 and at parts of the heating treatment portions 114a and 114b below the channel 112. The channel 112 in the respective heating treatment portions 114a and 114b is bent and formed in, for example, a zigzag shape so as to pass above the respective heaters 119a and 119b a plurality of times. Wiring lines (not shown) for connecting the heaters 119a and 119b with an external power source are led out of the respective heaters 119a and 119b onto the surface of the base 111. The respective wiring lines are formed of a metal material which has an electric resistance value lower than those of the material of the respective heaters 119a and 119b.

In the microchemical chip 101, fluids to-be-treated are caused to flow from the two supply portions 113a and 113b into the channel 112 and are merged into one, and the channel 112 is heated at a predetermined temperature with the heaters 119a and 119b in the heating treatment portions 114a and 114b, if necessary, so that the two kinds of fluids to-be-treated caused to flow in are reacted, and then the obtained reaction product is drawn from the collection portion 115.

In this embodiment, the base 111 includes a heat radiation plate 123 which is secured on a surface of the base body 120 opposite to the surface thereof where the lid 121 is secured, as a heat radiation portion for emitting heat generated from the heating treatment portions 114a and 114b out of the base 111. The heat radiation plate 123 is formed of a material whose thermal conductivity is higher than that of the base 111. For example, in a case where the base 111 is formed of ceramics, the heat radiation plate 123 is formed of copper, aluminum, a copper-tungsten alloy, a copper-molybdenum alloy, or the like. In order to heighten its close adhesion with the base 111, the heat radiation plate 123 is preferably fixed to the base 111 with a binder whose thermal conductivity is higher than that of the base 111. A silicone resin (“G750” produced by Shin-Etsu Chemical Co., Ltd.), for example, is employed as the binder. Alternatively, the heat radiation plate 123 may be brazed and fixed through a grease of high thermal conductivity, or it may be fixed with a silver-containing epoxy resin or silicone grease.

Since the heat radiation plate 123 is secured to the base 111 in this manner, the heat generated from the heating treatment portions 114a and 114b is emitted out of the base 111 through the heat radiation plate 123. Thus, influence which the heat from each of the heating treatment portions 114a and 114b exerts on the other can be suppressed, and a precise temperature control in each of the heating treatment portions 114a and 114b becomes possible. Therefore, in a case where a reaction product is to be produced by performing chemical reactions requiring heating, a plurality of times, each of the chemical reactions proceeds satisfactorily, and the desired reaction product can be obtained at a high yield.

Besides, since the heat radiation portion is constructed merely by arranging the heat radiation plate 123, it can be constructed with ease.

Further, the heat radiation plate 123 may be formed with penetrating holes 123a and 123b in its regions which oppose to surface parts of the base close to the respective heating treatment portions 114a and 114b. Surface parts of the base close to the respective heating treatment portions are preferably surface parts whose distances from the corresponding heating treatment portions are the shortest. In the case where the base 111 is in the shape of a flat plate as shown in FIGS. 12A and 12B, the surface parts of the base are preferably those of regions which are obtained by projecting the formation regions of the respective heating treatment portions 114a and 114b vertically onto the surface of the base 111.

With the heat radiation plate 123 which has the penetrating holes 123a and 123b in the regions opposing to the surface parts of the base close to the respective heating treatment portions 114a and 114b, heat emission from the surface parts of the base 111 close to the heating treatment portions 114a and 114b is suppressed, and heat conducted from the heating treatment portions 114a and 114b to the surroundings is emitted out of the base 111 by the heat radiation plate 123, so that the influence which the heat from each of the heating treatment portions 114a and 114b exerts on the other can be suppressed. In each of the heating treatment portions 114a and 114b, accordingly, sufficient heat can be ensured without being influenced by the other heating treatment portion 114b or 114a, so that a temperature suitable for the chemical reaction can be kept. Thus, the reaction product can be produced at the high yield.

Besides, the heat radiation plate 123 is preferably be thicker at its part between the penetrating holes 123a and 123b, than at the other part. In this case, heat emissivity is enhanced more at that part of the heat radiation plate 123 which lies between the heating treatment portions 114a and 114b, and these heating treatment portions 114a and 114b can be effectively restrained from exerting thermal influences on each other.

As the aforementioned embodiment, the cross-section area of the channel 112 and the supply channels 117a and 117b is preferably 2.5×10⁻³ mm² or more and 1 mm² or less in order to efficiently deliver and mix specimens, reagents, or cleaning liquids caused to flow in from the supply portions 113a and 113b.

For reduction in the size of the microchemical chip, an agitation portion for agitating the fluids to-be-treated may be formed on the downstream side in the flowing direction of the fluids to-be-treated with respect to the connection position 122 between the channel 112 and the supply portions 113a and 113b, as that of the first embodiment of the invention.

Besides, by forming the agitation portion between the connecting position 122 and the heating treatment portions 114a and 114b, the merged fluids to-be-treated have been sufficiently mixed in arriving at the heating treatment portions 114a and 114b. Accordingly, for example, in a case where a compound serving as a raw material is caused to flow in from the supply portion 113a, where a reagent is caused to flow in from the supply portion 113b, and where the compound and the reagent are merged and are reacted by heating them with the heaters 119a and 119b of the heating treatment portions 114a and 114b, the compound and the reagent can be heated in a state where they have been sufficiently mixed. It is therefore possible to efficiently react the compound and the reagent, and to enhance the yield of a reaction product which is taken out of the collection portion 115.

As the base body 120, a base body made of a ceramic material, silicon, glass, or resin can be used, and among these, it is preferable to use a base body made of the ceramic material, as the aforementioned embodiment.

As the aforementioned embodiment, the lid 121 can be formed of glass or a ceramic material, but it is preferable to use glass for the lid 121 because the mixed state or the reaction state of the fluids to-be-treated can be visually confirmed.

For the same reason as the aforementioned embodiment, the cross-section area of the channel 112 and the supply channels 117a and 117b is preferably 2.5×10⁻³ mm² or more and 1 mm² or less in order to efficiently deliver and mix specimens, reagents, or cleaning liquids poured from the supply portions 113a and 113b.

As the aforementioned embodiment, the width w of the channel 112 and the supply channels 117a and 117b is preferably 50 to 1000 μm, more preferably 100 to 500 μm. As the aforementioned embodiment, the depth d of the channel 112 and the supply channels 117a and 117b is preferably 50 to 1000 μm, more preferably 100 to 500 μm, and within the preferable range of the cross-section area as described above. As the aforementioned embodiment, when the cross-sectional shapes of the channel 112 and the supply channels 117a and 117b are of a rectangular shape, the relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

The outline size of the microchemical chip 101 is, for example, such that the width A is about 40 mm, the depth B is about 70 mm, and the height C is about 1 to 2 mm, but the invention is not limited thereto, and an appropriate outline size can be used, depending on the necessity.

The microchemical chip 101 after use can be used again when the microchemical chip is cleaned by pouring a cleaning liquid from the supply portions 113a and 113b.

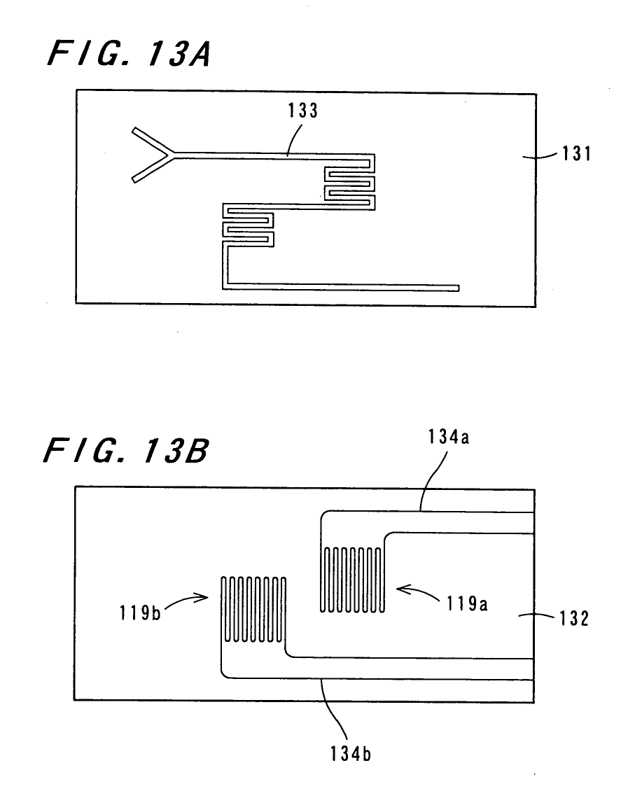

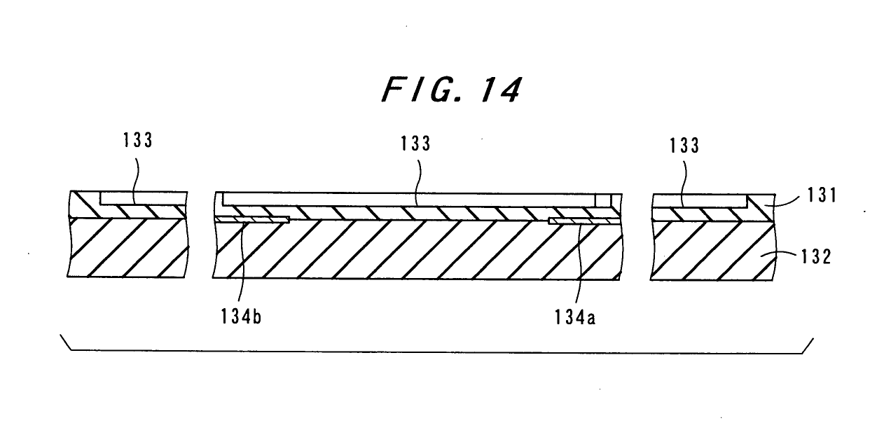

Next, a method of manufacturing the microchemical chip 101 shown in FIGS. 12A and 12B will be described. This embodiment shall be described about a case where the base body 120 is made of a ceramic material. FIGS. 13A and 13B are plan views showing the states of the processed ceramic green sheets 131 and 132, respectively. FIG. 14 is a sectional view showing a state where the ceramic sheets 131 and 132 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the base body 120 is made of an aluminum oxide sintered substance, aluminum oxide, silicon oxide, magnesium oxide, and calcium oxide or the like can be used.

In this embodiment, two of the thus formed ceramic green sheets are used to form the base body 120. First, as shown in FIG. 13A, the groove portion 133 is formed by pressing the surface of the first ceramic green sheet 131 with a pattern. In this case, a pattern having a shape to which desired shape of the groove portion 133 is transferred is used. Incidentally, by using a pattern in which an uneven shape is transferred on a portion corresponding to a predetermined wall surface part, as the shape of the groove portion 133, unevenness can be formed on a wall surface part of the groove portion 133 which constitutes the uneven portion serving as the agitation portion stated before.

The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 13B, the heaters 119a and 119b and wiring patterns 134a and 134b for external power connection are formed on the surface of the ceramic green sheet 132 by applying a conductive paste in a predetermined shape by screen printing or the like. The wiring patterns 134a and 134b constituting the heaters 119a and 119b are bent and formed in, for example, a zigzag shape at parts corresponding to the heating treatment portions 114a and 114b. The conductive paste can be obtained by mixing a metal material powder such as tungsten, molybdenum, manganese, copper, silver, nickel, palladium, or gold with a suitable organic binder and solvent. For the conductive paste which forms the wiring patterns 134a and 134b constituting the respective heaters 119a and 119b, a conductive paste in which 5 to 30 wt % of a ceramic powder is added to a metal material powder as described above such that a predetermined electric resistance value is achieved after firing is used.

As shown in FIG. 14, the ceramic green sheet 131 in which the groove portion 133 is formed is laminated on the surface of the ceramic green sheet 132 in which the wiring patterns 134a and 134b constituting the heaters 119a and 119b are formed. The laminated ceramic green sheets 131 and 132 are sintered at a temperature of about 1600° C. Thus, the base body 120 shown in FIGS. 12A and 12B is formed.

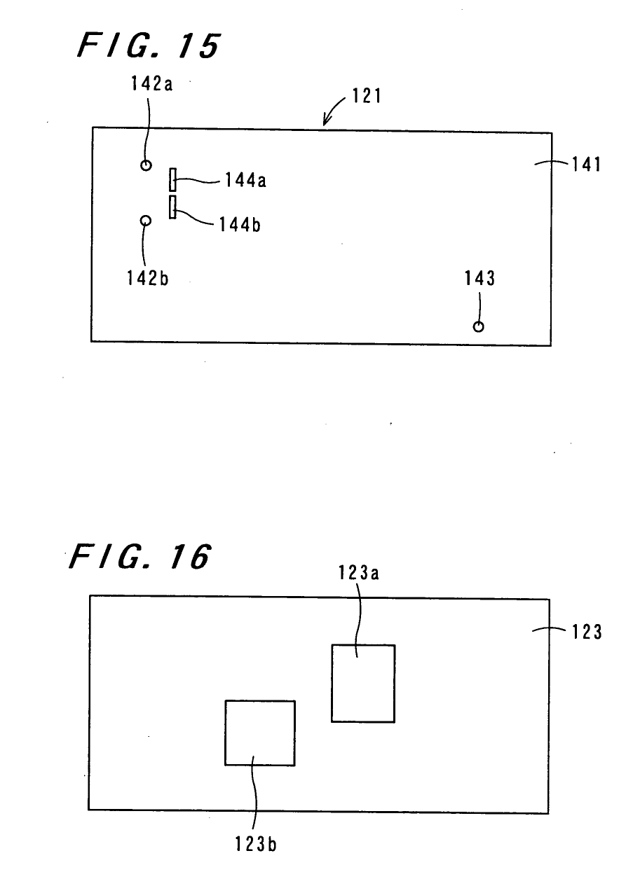

FIG. 15 is a plan view showing a simplified structure of the lid 121. As shown in FIG. 15, the through-holes 142a, 142b and 143 that are in communication with the groove portion 133 of ceramic green sheet 131 shown in FIG. 13A are formed in the predetermined positions that are to serve as the supply ports 116a and 116b and the collection portion 115 in a substrate 141 made of, for example, glass or a ceramic material, and thus the lid 121 can be obtained.

The lid 121 is bonded onto the surface on which the groove portion 133 is exposed of the base body 120. For example, the lid 121 and the base body 120 are bonded by heating and pressing when the lid 121 is made of glass, and are bonded with a glass adhesive when the lid 121 is made of a ceramic material.

Piezoelectric materials 144a and 144b such as lead zirconate titanate (PZT; composition formula: Pb(Zr, Ti)O₃) are attached into predetermined positions on the surface of the lid 121, and conduction lines (not shown) for applying a voltage to the piezoelectric materials 144a and 144b are formed. The piezoelectric materials 144a and 144b can vibrate the lid 121 above the supply channels 117a and 117b by expanding or contracting in accordance with the applied voltage, and therefore micropumps 118a and 118b for delivering fluids can be formed by attaching the piezoelectric materials 144a and 144b to the lid 121 above the supply channels 117a and 117b.

FIG. 16 is a plan view of the heat radiation plate 123. The heat radiation plate 123 is a member in a shape of a rectangular flat plate which has the same size as that of the planar shape of the base body 120, and it has the rectangular penetrating holes 123a and 123b at positions corresponding to the heating treatment portions 114a and 114b (refer to FIG. 12A) formed in rectangular shapes, respectively. After the base body 120 and the lid 121 have been laminated together, the heat radiation plate 123 is secured onto the surface of the base body 120 opposite to the surface thereof on which the lid 121 has been laminated, by employing a binder such as silicone resin.

In the above way, the microchemical chip 101 shown in FIGS. 12A and 12B is obtained. In this manner, the microchemical chip 101 which includes the heat radiation plate 123 that is the heat radiation portion for emitting the heat from the heating treatment portions 114a and 114b out of the base 111 can be manufactured by laminating the base body 120 and the lid 121 together and thereafter securing the heat radiation plate 123.

In this embodiment, the base body 120 is formed by sintering the laminated structure which consists of the ceramic green sheet 131 in a surface of which the groove portion 133 is formed by pressing with a pattern, and the ceramic green sheet 132 in which the wiring patterns 134a and 134b constituting the heaters 119a and 119b are formed, whereupon the base 111 having the channel 112 is formed by covering the groove portion 133 in the surface of the base body 120 with the lid 121. Therefore, the microchemical chip 101 can be produced only by simple processing without performing complicated processing such as etching processing that is necessary when forming a channel in the base 111 made of silicon, glass or resin.

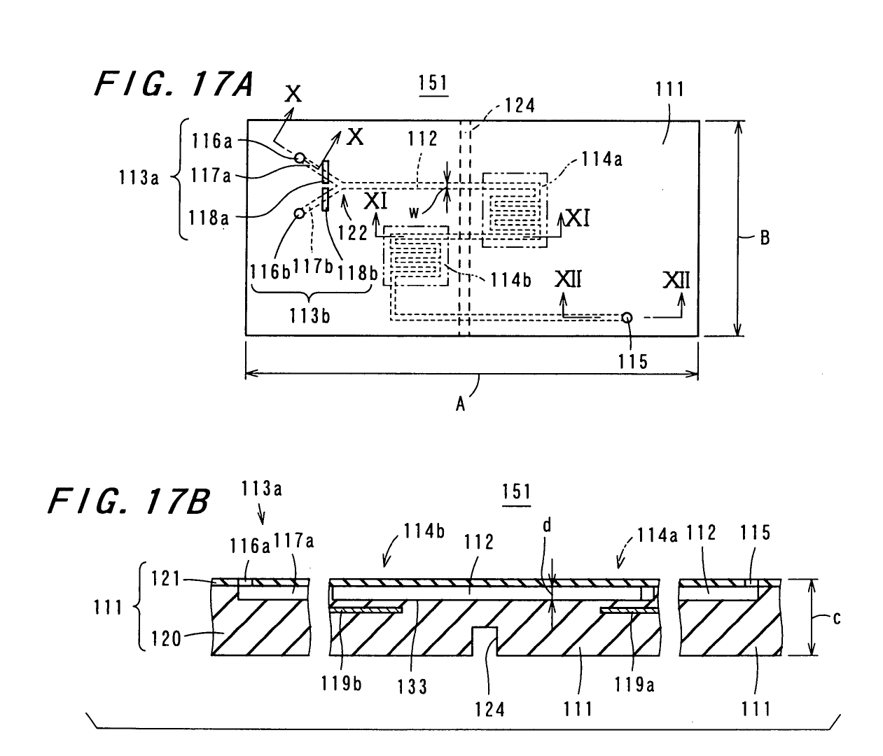

Besides, as the microchemical chip 151 of a fourth embodiment of the invention, a groove 124 may be formed in a region which lies on the rear surface side of the base body 120 (opposite side to the surface on which the lid 121 is stuck) and between the heating treatment portions 114a and 114b, as shown in FIGS. 17A and 17B, instead of securing the heat radiation plate 123.

The groove 124 may be formed over the full width of the base body 120 as shown in FIGS. 17A and 17B, or it may be formed like a concavity at a partial width of the base body 120. When the groove 124 is formed at the partial width, the groove is preferably formed in a region which traverses a belt-like region joining the heating treatment portions 114a and 114b. Besides, the shape of the groove 124 which is formed at the partial width is not restricted to a slender rectangle, but it may be an ellipse or a circle. That is, the shape of the groove 124 is not especially restricted as long as a vacant space exists in the belt-like region which joins the heating treatment portions 114a and 114b.

Since the groove 124 serving as the heat radiation portion is formed in the region between the heating treatment portions 114a and 114b, heat conducted in a direction from each of the heating treatment portions 114a and 114b toward the other is emitted out of the base 111 from the wall surface/surfaces and bottom surface of the groove 124. Accordingly, the same advantages as in the case of securing the heat radiation plate 123 can be attained.

Moreover, since the heat radiation portion is constructed by forming the groove 124 in the base body 120 constituting the base 111, the microchemical chip 151 can be made smaller in construction and lighter in weight in comparison with the case of employing a separate component such as the heat radiation plate 123.

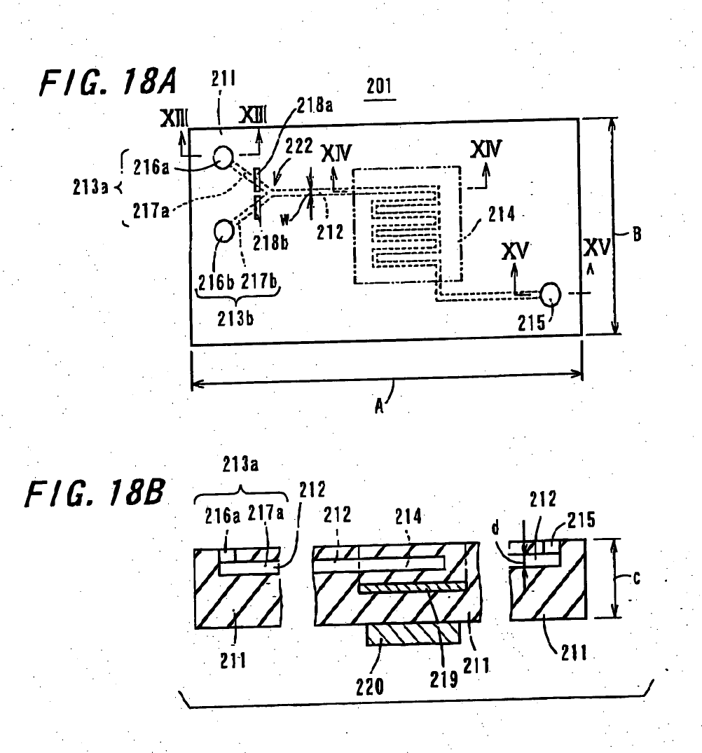

FIG. 18A is a plan view showing the basic construction of the microchemical chip 201 according to a fifth embodiment of the invention, and FIG. 18B is a sectional view showing the sectional constructions of the microchemical chip 201 as are taken along cutting lines XIII-XIII, XIV-XIV and XV-XV indicated in FIG. 18A. By the way, in FIG. 18B, the sectional constructions taken along the cutting lines XIII-XIII, XIV-XIV and XV-XV are shown in this order.

The microchemical chip 201 of the invention has a base 211 made of a ceramic material or the like, and a channel 212, two supply portions 213a and 213b, a heating treatment portion (reaction portion) 214 and a collection portion 215 are provided on an upper surface side of the base 211. The supply portion 213a includes a supply channel 217a connected to the channel 212, a supply port 216a which is provided at an end part of the supply channel 217a, and a micropump 218a which is provided above the supply channel 217a. Likewise, the supply portion 213b includes a supply channel 217b connected to the channel 212, a supply port 216b which is provided at an end part of the supply channel 217b, and a micropump 218b which is provided above the supply channel 217b. The supply ports 216a and 216b are opened such that a fluid to-be-treated can be poured into the supply channels 217a and 217b from the outside. The collection portion 215 is configured as an opening such that a treated fluid is removed from the channel 212 to the outside. The heating treatment portion 214 lies on the downstream sides in a flowing direction of the fluids to-be-treated of a connecting position 222 where two supply portions 213a and 213b and the channel 212 are connected.

A heater 219 is disposed within the base 211 and at a part of the heating treatment portion 214 serving as the reaction portion below the channel 212. The channel 212 in the heating treatment portion 214 is bent and formed in, for example, a zigzag shape so as to pass above the heater 219 a plurality of times. A wiring line (not shown) for connecting the heater 219 with an external power source is led out of the heater 219 onto the surface of the base 211. The wiring line is formed of a metal material which has an electric resistance value lower than that of the material of the heater 219.

In the microchemical chip 201, fluids to-be-treated are caused to flow from the two supply portions 213a and 213b into the channel 212 and are merged into one, and the channel 212 is heated at a predetermined temperature with the heater 219 in the heating treatment portion 214 so that the two kinds of fluids to-be-treated caused to flow in are reacted, and then the obtained reaction product is drawn from the collection portion 215.

In the invention, a heat radiation plate 220 which has an external size smaller than that of the heater 219 and an external shape similar to that of the heater 219 is arranged on a part of a lower surface of the base 211 which lies underneath the heater 219, namely on a surface of the base 211 which surface is close to the heater 219 so as to oppose the heater 219. The heat radiation plate 220 serves to uniformize the temperature distribution of the heating treatment portion 214. Since the heat radiation plate 220 has the external size smaller than that of the heater 219 and the external shape similar to that of the heater 219, the heat emissivity of the central part of the heater 219 is heightened, and the temperature difference between the central part and outer peripheral parts of the heater 219 can be effectively made small. As a result, the temperature distribution of the heating treatment portion 214 can be precisely uniformized.

Besides, in the invention, the area of the heat radiation plate 220 as viewed in plan should preferably be 50 to 90% of that of the heater 219 as viewed in plan. Thus, the temperature difference between the central part and outer peripheral parts of the heater 219 can be made still smaller, with the result that the temperature of the reaction portion can be controlled more uniformly and precisely. In a case where the area of the heat radiation plate 220 as viewed in plan is less than 50% of that of the heater 219 as viewed in plan, the heat emissivity of the central part of the heater 219 lowers, and it becomes difficult to make small the temperature difference between the central part and outer peripheral parts of the heater 219. When the area of the heat radiation plate 220 as viewed in plan exceeds 90% of that of the heater 219 as viewed in plan, heat is radiated similarly to heat radiation in the case of providing a heat radiation plate 220 which has the same size as that of the heater 219, and the heat emissivities of the central part and outer peripheral parts of the heater 219 become substantially the same. Therefore, the temperature of the outer peripheral parts from which the heat is easy of diffusion becomes liable to lower, and it becomes difficult to make small the temperature difference between the central part and outer peripheral parts of the heater 219.

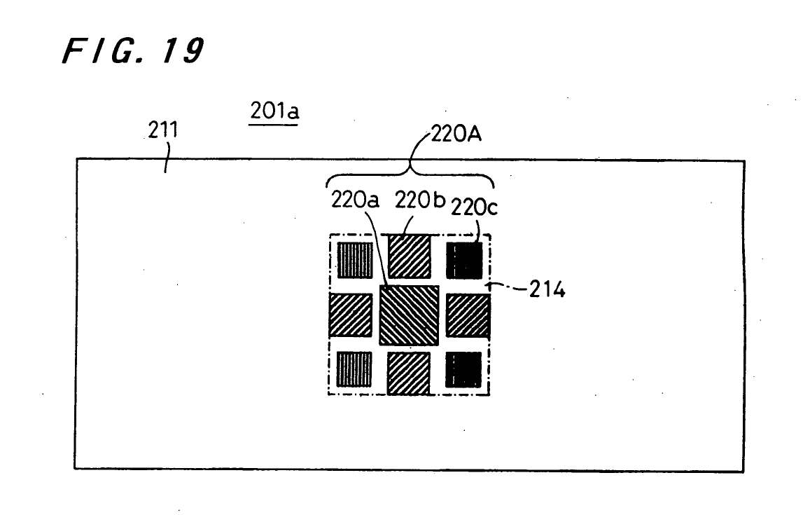

Besides, as the microchemical chip 201a according to a sixth embodiment of the invention, the heat radiation plate 220A may be constructed in such a way that heat radiation plates 220a, 220b and 220c of different sizes are combined as shown in FIG. 19. By way of example, the heat radiation plates 220a, 220b and 220c are made of copper plates of 1.5 mm thick, respectively, and they are joined to the base 211 with silicone resin of high thermal conductivity (for example, “G750” produced by Shin-Etsu Chemical Co., Ltd.). The heat radiation plate 220 is formed of the heat radiation plate 220a which is disposed on that part of the lower surface of the base 211 which lies underneath the central part of the heater 219, and the heat radiation plates 220b and 220c which are disposed around the heat radiation plate 220a. The areas of the heat radiation plates 220a, 220b and 220c are larger in the order of the heat radiation plate 220a, each heat radiation plate 220b and each heat radiation plate 220c. Thus, the heat emissivity of the central part of the heater 219 can be made higher than those of the outer peripheral parts, and the temperature of the heating treatment portion 214 can be controlled uniformly and precisely.

More specifically, in the case of FIG. 19, the heat emissivities are higher in the order of the heat radiation plate 220a which is located underneath the central part of the tetragonal heater 219, the heat radiation plates 220b which are located at the four sides of the heater 219, and the heat radiation plates 220c which are located at the four corners of the heater 219.

Besides, in the case of FIG. 19, the total area of the heat radiation plates 220a, 220b and 220c may be 50 to 90% of the area of the heater 219.

For example, in a case where a fluid which contains a compound serving as a raw material is caused to flow in from the supply portion 213a, where a fluid which contains a reagent is caused to flow in from the supply portion 213b, and where the channel 212 in the heating treatment portion 214 is heated by the heater 219, a compound can be synthesized, and the obtained compound can be derived from the collection portion 215. Besides, as another embodiment, when a detection portion is provided at the collection portion 215 or on the upstream side in the flowing direction of the fluids to-be-treated with respect to this collection portion 215, the reaction product of a chemical reaction or a biochemical reaction such as antigen-antibody reaction or enzyme reaction can be detected.

The microchemical chip 201 after use can be used again when the microchemical chip 201 is cleaned by pouring a cleaning liquid from the supply portions 213a and 213b.

For the same reason as the aforementioned embodiment, the cross-section area of the channel 212 and the supply channels 217a and 217b is preferably 2.5×10⁻³ mm² or more and 1 mm² or less in order to efficiently deliver and mix specimens, reagents, or cleaning liquids poured from the supply portions 213a and 213b.

As the aforementioned embodiment, the width w of the channel 212 and the supply channels 217a and 217b is preferably 50 to 1000 μm, more preferably 100 to 500 μm. As the aforementioned embodiment, the depth d of the channel 212 and the supply channels 217a and 217b is preferably 50 to 1000 μm, more preferably 100 to 500 μm, and within the preferable range of the cross-section area as described above. As the aforementioned embodiment, when the cross-sectional shapes of the channel 212 and the supply channels 217a and 217b are of a rectangular shape, the relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

The outline size of the microchemical chip 201 is, for example, such that the width A is about 40 mm, the depth B is about 70 mm, and the height C is about 1 to 2 mm, but the invention is not limited thereto, and an appropriate outline size can be used, depending on the necessity.

As described above, the microchemical chip 1, 51, 101, 151, 201 and 201a according to the first to the sixth embodiments has the two supply portions 13a and 13b; 63a and 63b; 113a and 113b; 213a and 213b, but it may have three or more supply portions without being restricted to the exemplary construction. Besides, in the case where the two or more supply portions are provided, they need not be disposed so as to merge at one point, but they may be disposed so as to be respectively connected to the different positions of the channel 12, 62, 112 and 212. In the case of the first embodiment of the invention, the supply channels of the respective supply portions are formed with heaters for heating fluids to-be-treated flowing through the corresponding flow channels.

In the case of the second embodiment of the invention, when the plurality of supply portions are respectively connected to the different positions of the channel 62, the enlarged portion 62a may be formed between the heating treatment portion 64 and the connecting position on the most downstream side in the flowing direction of the fluids to-be-treated.

In the cases of the fifth and the sixth embodiments of the invention, the heater 219 is constructed as being provided in one place, but such heaters may be disposed in two or more places without being restricted to the exemplary construction. Thus, a complicated reaction can be controlled by disposing the three or more supply portions and the heaters in the two or more places.

Besides, the microchemical chip 1, 51, 101, 151, 201 and 201a of the first to the sixth embodiments is provided with the collection portion 15, 65, 115 and 215 from which a reaction product is drawn. In this regard, when a detection portion is provided at the collection portion 15, 65, 115 and 215 or on the upstream side in the flowing direction of the fluids to-be-treated with respect to this collection portion 15, 65, 115 and 215, the reaction product of a chemical reaction or a biochemical reaction such as antigen-antibody reaction or enzyme reaction can be detected.

Besides, in the first to the sixth embodiments, the construction in which the micropumps 18a and 18b; 68a and 68b; 118a and 118b; 218a and 218b are provided as the fluid feed means is adopted, but it is also possible to adopt a construction in which the micropumps 18a and 18b; 68a and 68b; 118a and 118b; 218a and 218b are not provided. In this case, the fluids to-be-treated can be fed from the supply port 16a and 16b; 66a and 66b; 116a and 116b; 216a and 216b to the collection portion 15, 65, 115 and 215 in such a way that in pouring the fluids to-be-treated from the supply port 16a and 16b; 66a and 66b; 116a and 116b; 216a and 216b they are pushed in by microsyringes or the likes. Alternatively, the fluids to-be-treated can be fed in such a way that, in pouring the fluids, they are poured while being pressurized by pumps or the likes disposed outside. Also, the fluids to-be-treated can be fed in such a way that, after the fluids have been poured from the supply port 16a and 16b; 66a and 66b; 116a and 116b; 216a and 216b they are drawn by a microsyringe or the like from the collection portion 15, 65, 115 and 215 which is incarnated by the opening.

Besides, although the lid 21, 71 and 121 are bonded to the base body 20, 70 and 120, it may be mounted so as to be detachable from the base body 20, 70 and 120 without being restricted to the bonding. It is also allowed to adopt, for example, a construction in which silicone rubber or the like is interposed between the base body 20, 70 and 120 and the lid 21, 71 and 121 so as to apply a pressure to the whole microchemical chip.

Besides, in the method of manufacturing the microchemical chip 1 of the first embodiment, the base body 20 is formed of the two ceramic green sheets, namely, the ceramic green sheet 31 having the groove portion 33, and the ceramic green sheet 32 having the wiring line patterns 34, 35a and 35b for the respective heaters 19, 23a and 23b, but the base body may be formed of three or more ceramic green sheets without being restricted to the exemplary construction.

Besides, in the method of manufacturing the microchemical chip 51 of the second embodiment, the base body 70 is formed of the two ceramic green sheets, namely, the ceramic green sheet 81 having the groove portion 83, and the ceramic green sheet 82 having the wiring line pattern 84 for the heater 69, but it may be formed of three or more ceramic green sheets without being restricted to the exemplary construction.

Besides, in the method of manufacturing the microchemical chip 101 and 151 of the third and the fourth embodiments, the base body 120 is formed of the two ceramic green sheets, namely, the ceramic green sheet 131 having the groove portion 133, and the ceramic green sheet 132 having the wiring line patterns 134a and 134b for the respective heaters 119a and 119b, but it may be formed of three or more ceramic green sheets without being restricted to the exemplary construction.

Besides, in the method of manufacturing the microchemical chip 1, 51, 101 and 151 of the first to the fourth embodiments, the base 11, 61 and 111 are formed in such a way that the ceramic green sheet 31, 81 and 131 is sintered with the groove portion 33, 83 and 133 in the surface of the ceramic green sheet 31, 81 and 131 exposed, thereby to form the base body 20, 70 and 120 whereupon the groove portion 33, 83, 133 in the surface of the base body 20, 70 and 120 is covered with the lid 21, 71 and 121. However, without being restricted to the above method, a base may be formed in such a way that a ceramic green sheet having through holes, which are similar to those of the lid 21, 71 and 121 and which communicate with the groove portion 33, 83 and 133 is further laminated on the surface of the ceramic green sheet 31, 81 and 131 and that the resulting laminated structure is sintered. When the base 11, 61 and 111 are formed in this way, it is dispensed with to mount the lid 21, 71 and 121 after the formation of the base body 20, 70 and 120 and hence, productivity can be enhanced. Besides, in the case where the PZT or the like ceramic piezoelectric material as stated before is employed for the piezoelectric materials 44a and 44b; 94a and 94b; 144a and 144b constituting the respective micropumps 18a and 18b; 68a and 68b; 118a and 118b, it is also possible to attach the ceramic piezoelectric material to the predetermined positions of a ceramic green sheet having through holes communicating with the groove portion 33, 83, 133 and to sinter the ceramic green sheet simultaneously with the ceramic green sheets.

The microchemical chip of the invention can be used for applications such as tests of viruses, bacteria or humor components in humors such as blood, saliva and urine with a reagent, vital reaction experiments between viruses, bacteria or medical fluid and body cells, reaction experiments between viruses or bacteria and medical fluid, reaction experiments between viruses or bacteria and other viruses or bacteria, blood identification, separation and extraction or decomposition of genes with medical fluid, separation and extraction by precipitation or the like of a chemical substance in a solution, decomposition of a chemical substance in a solution, and mixture of a plurality of medical fluids, and can be used for the purpose of other vital reactions or chemical reactions.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A microchemical chip comprising:
a base including a channel for causing fluids to-be-treated to flow therethrough, and a plurality of supply portions connected to the channel, for causing the plurality of fluids to-be-treated to flow into the channel, respectively, the plurality of fluids to-be-treated being respectively caused to flow from the plurality of supply portions into the channel, and the plurality of fluids to-be-treated caused to flow in being merged to be subjected to a predetermined treatment,
wherein each of the supply portions includes a supply channel, one end of which is connected to an opening formed in the base and another end of which is connected to the channel, and heating means for heating the fluid to-be-treated flowing through the supply channel.

2. The microchemical chip of claim 1, wherein the base further includes a collection portion connected to the channel and from which the treated fluid is drawn to the outside, and
wherein the plurality of fluids to-be-treated are respectively caused to flow from the plurality of supply portions into the channel, the plurality of fluids to-be-treated caused to flow in are merged to be subjected to the predetermined treatment, and thereafter the treated fluid is drawn from the collection portion to the outside.

3. The microchemical chip of claim 1, wherein the base further includes a heating treatment portion for heating the merged fluids to-be-treated and performing the predetermined treatment thereto, the heating treatment portion being disposed on a downstream side in a flowing direction of the fluids to-be-treated with respect to a position where the supply portions and the channel are connected.

4. The microchemical chip of claim 2, wherein the base further includes a heating treatment portion for heating the merged fluids to-be-treated and performing the predetermined treatment thereto, the heating treatment portion being disposed on a downstream side in a flowing direction of the fluids to-be-treated with respect to a position where the supply portions and the channel are connected.

5. A microchemical chip comprising:
a base including a channel for causing fluids to-be-treated to flow therethrough, a plurality of supply portions connected to the channel, for causing the plurality of fluids to-be-treated to flow into the channel, respectively, and a heating treatment portion for heating the merged fluids to-be-treated and performing a predetermined treatment thereto, the heating treatment portion being disposed on a downstream side in a flowing direction of the fluids to-be-treated with respect to a position where the supply portions and the channel are connected, the plurality of fluids to-be-treated being respectively caused to flow from the plurality of supply portions into the channel, and the plurality of fluids to-be-treated caused to flow in being merged to be subjected to the predetermined treatment,
wherein the channel includes, between the heating treatment portion and the position where the supply portions are connected, an enlarged portion having a cross-sectional area larger than each of those of upstream and downstream channel parts.

6. The microchemical chip of claim 5, wherein a length of the enlarged portion is 3 to 10 mm.

7. The microchimical chip of claim 5, wherein a cross-sectional area of the enlarged portion is at least 1.5 times as large as each of cross-sectional areas of the upstream and downstream channel parts.

8. The microchimical chip of claim 5, wherein the base further includes a collection portion connected to the channel on the downstream side in the flowing direction of the fluids to-be-treated with respect to the heating treatment portion, from which the treated fluid is drawn to the outside, and
wherein the plurality of fluids to-be-treated are respectively caused to flow from the plurality of supply portions into the channel, the plurality of fluids to-be-treated caused to flow in are merged, heated in the heating treatment portion and subjected to the predetermined treatment, and thereafter the treated fluid is drawn from the collection portion to the outside.

9. A microchemical chip comprising:
a base including a channel for causing fluids to-be-treated to flow therethrough, a plurality of supply portions connected to the channel, for causing the plurality of fluids to-be-treated to flow into the channel, respectively, and a heating treatment portion for heating the merged fluids to-be-treated and performing the predetermined treatment thereto, the heating treatment portion being disposed on a downstream side in a flowing direction of the fluids to-be-treated with respect to a position where the supply portions and the channel are connected, the plurality of fluids to-be-treated being respectively caused to flow from the plurality of supply portions into the channel, and the plurality of fluids to-be-treated caused to flow in being merged to be subjected to a predetermined treatment,
wherein the base further includes a heat radiation portion for emitting heat generated from the heating treatment portion out of the base.

10. The microchemical chip of claim 9, wherein the base includes a plurality of heating treatment portions.

11. The microchemical chip of claim 9, wherein the heat radiation portion is composed of a heat radiation plate arranged in contact with a surface of the base, the heat radiation plate being made of a material having a thermal conductivity higher than that of the base.

12. The microchemical chip of claim 9, wherein the heat radiation portion has penetrating holes in regions which oppose to parts of the surface of the base close to the heating treatment portions.

13. The microchemical chip of claim 10, wherein the heat radiation portion is composed of a groove formed in a region of the base as lies between the plurality of heating treatment portions.

14. The microchemical chip of claim 9, wherein the heating treatment portion includes a heater disposed within the base, and
wherein the heat radiation portion has a heat radiation plate having an external size smaller than that of the heater and an external shape similar to that of the heater, the heat radiation plate being arranged on a surface of the base which surface is close to the heater so as to oppose the heater.

15. The microchimical chip of claim 14, wherein an area of the radiation plate as viewed in plan reaches 50 to 90% of an area of the heater as viewed in plan.

16. The microchemical chip of claim 9, wherein the base further includes a collection portion connected to the channel and from which the treated fluid is drawn to the outside, and
wherein the reaction product is drawn from the collection portion to the outside.
